(19) United States
(12) Patent Application Publication
(10) Pub. No.: US 2023/0255401 A1
(43) Pub. Date: Aug. 17, 2023

(54) METHODS AND APPARATUS FOR PRESENTING LOCATION-BASED FOOD MOVEMENT NOTIFICATIONS IN CONNECTION WITH COOK PROGRAMS OF GRILLS

(71) Applicant: Weber-Stephen Products LLC, Palatine, IL (US)

(72) Inventors: Kevin James Glennon, Hoffman Estates, IL (US); William Alexander Mecker, Kildeer, IL (US)

(21) Appl. No.: 17/984,098

(22) Filed: Nov. 9, 2022

Related U.S. Application Data
(60) Provisional application No. 63/310,511, filed on Feb. 15, 2022.

(51) Int. Cl. A47J 37/07; A47J 36/32; A23L 5/10

(52) U.S. Cl. CPC A47J 37/0713; A47J 36/321; A23L 5/15; F24C 3/126

(57) ABSTRACT

Example methods and apparatus for presenting location-based food movement notifications in connection with cook programs of grills are disclosed. An example grill includes a cookbox, a lid, a cooking chamber, a controller, and a lighting module. The cooking chamber is defined by the cookbox and the lid. The controller implements a cook program to cook an item of food within the cooking chamber. The cook program includes a food movement step requiring the item of food to be added to the cooking chamber, to be removed from the cooking chamber, or to be moved within the cooking chamber. In response to determining that the cook program has advanced to the food movement step, the controller causes the lighting module to present a location-based food movement notification indicating a location within the cooking chamber at which the food movement step is to be performed.

### RELATED APPLICATIONS

This application claims priority to U.S. Provisional Patent Application No. 63/310,511, filed Feb. 15, 2022. The entirety of U.S. Provisional Patent Application No. 63/310,511 is hereby incorporated by reference herein.

### FIELD OF THE DISCLOSURE

This disclosure relates generally to the presentation of notifications for grills and, more specifically, to methods and apparatus for presenting location-based food movement notifications in connection with cook programs of grills.

### BACKGROUND

Some known grills are equipped with a controller configured to implement various controlled cooking operations and/or steps in association with one or more selectable cook program(s). Each cook program includes a plurality of ordered steps, some of which can be performed in an automated manner at the direction of the controller (e.g., increasing or decreasing a temperature within a cooking chamber of the grill), and others of which require user (e.g., human) interaction with some aspect of the grill. For example, it is common for any cook program to include at least one “food movement step” that requires a user of the grill to add an item of food to the cooking chamber of the grill (e.g., at or toward the beginning of a cook), to remove an item of food from the cooking chamber of the grill (e.g., at or toward the end of a cook), and/or to flip, rotate, relocate, or otherwise move an item of food within the cooking chamber of the grill (e.g., during the middle of a cook).

In conventional implementations, each food movement step of a cook program is prefaced and/or accompanied by a textual and/or graphical user notification that is presented either locally at the grill (e.g., via one or more output device(s) of a user interface of the grill), or at a remote device in wireless electrical communication with the grill and in the user's possession. When presented in their conventional form, such textual and/or graphical user notifications fail to provide the user with an intuitive “at-the-cookbox” visual identification of the specific location within the cooking chamber of the grill at which the food movement step is to occur. The user of the grill is accordingly left to exercise their best judgment when interpreting such conventional textual and/or graphical user notifications in the course of deciding which specific area(s) and/or specific location(s) within the cooking chamber of the grill the associated food movement steps might apply to.

### BRIEF DESCRIPTION OF THE DRAWINGS

FIG. 1 is a block diagram of an example grill constructed in accordance with the teachings of this disclosure.

FIG. 2 is a perspective view of an example implementation of the grill of FIG. 1, with an example lid of the grill shown in an example closed position relative to an example cookbox of the grill.

FIG. 3 is a perspective view of the implementation of the grill shown in FIG. 2, with the lid of the grill shown in an example open position relative to the cookbox of the grill.

FIG. 4 is an exploded view of the implementation of the grill shown in FIGS. 2 and 3.

FIG. 5 is a perspective view of the cookbox of the implementation of the grill shown in FIGS. 2-4.

FIG. 6 is a partial cross-sectional view of the implementation of the grill shown in FIGS. 2-4.

FIG. 7 a front view of an example lighting module that may be implemented as one of the lighting module(s) of FIG. 1.

FIG. 8 is a front view of the lighting module shown in FIG. 7, with the control knob of FIG. 7 removed.

FIG. 9 is a side view of the lighting module shown in FIGS. 7 and 8, with the control knob of FIG. 7 removed.

FIG. 10 is another front view of the lighting module shown in FIGS. 7-9, with the control knob of FIG. 7 included.

FIG. 11 is another front view of the lighting module shown in FIGS. 7-9, with the control knob of FIG. 7 included.

FIG. 12 is another front view of the lighting module shown in FIGS. 7-9, with the control knob of FIG. 7 removed.

FIG. 13 is a perspective view of another example grill configured to present location-based food movement notifications.

FIG. 14 is a perspective view of the grill of FIG. 13, with the third lighting module of FIG. 13 shown presenting an example location-based food movement notification.

FIG. 15 is a perspective view of the grill of FIGS. 13 and 14, with example items of food shown added to the third area of the cooking grate of FIGS. 13 and 14.

FIG. 16 is a perspective view of the grill of FIGS. 13-15, with the first lighting module of FIGS. 13-15 shown presenting an example location-based food movement notification.

FIG. 17 is a perspective view of the grill of FIGS. 13-16, with the second lighting module of FIGS. 13-16 shown presenting an example location-based food movement notification.

FIG. 18 is a perspective view of the grill of FIGS. 13-17, with the first lighting module, the second lighting module, and the third lighting module of FIGS. 13-17 shown presenting corresponding example location-based food movement notifications.

FIG. 19 a front view of another example lighting module that may be implemented as one of the lighting module(s) of FIG. 1.

FIG. 20 is a front view of an example user interface that may be implemented as the user interface of FIG. 1.

FIG. 21 is a logical representation of an example cook program to be implemented by the grill of FIG. 1.

FIG. 22 is a flowchart representative of example machine-readable instructions and/or example operations that may be executed by processor circuitry to implement a location-based food movement notification process of the grill of FIG. 1.

FIG. 23 is a block diagram of an example processor platform including processor circuitry structured to execute and/or instantiate the machine-readable instructions and/or operations of FIG. 22 to implement the grill of FIG. 1.

FIG. 24 is a block diagram of an example implementation of the processor circuitry of FIG. 23.

FIG. 25 is a block diagram of another example implementation of the processor circuitry of FIG. 23.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

As discussed above, it is common for any controlled cook program of a grill to include at least one “food movement step” that requires a user of the grill to add an item of food to the cooking chamber of the grill (e.g., at or toward the beginning of a cook), to remove an item of food from the cooking chamber of the grill (e.g., at or toward the end of a cook), and/or to flip, rotate, relocate, or otherwise move an item of food within the cooking chamber of the grill (e.g., during the middle of a cook). In conventional implementations, each food movement step of a cook program is prefaced and/or accompanied by a textual and/or graphical user notification that is presented either locally at the grill (e.g., via one or more output device(s) of a user interface of the grill), or at a remote device in wireless electrical communication with the grill and in the user's possession. When presented in their conventional form, such textual and/or graphical user notifications fail to provide the user with an intuitive “at-the-cookbox” visual identification of the specific location within the cooking chamber of the grill at which the food movement step is to occur. The user of the grill is accordingly left to exercise their best judgment when interpreting such conventional textual and/or graphical user notifications in the course of deciding which specific area(s) and/or specific location(s) within the cooking chamber of the grill the associated food movement steps might apply to.

Relative to the known cook program implementations described above, which present textual and/or graphical user notifications that fail to provide the user with an intuitive “at-the-cookbox” visual identification of the specific location within the cooking chamber of the grill at which a food movement step is to occur, the methods and apparatus disclosed herein advantageously present location-based food movement notifications that intuitively inform the user of the grill (e.g., via one or more viewable, light-based indication(s)) of one or more area(s) and/or location(s) within the cooking chamber of the grill at which one or more associated food movement step(s) of a cook program being executed by the controller of the grill is/are to be performed. Such location-based food movement notifications advantageously reduce (e.g., minimize and/or remove) the degree of guesswork and/or judgment which the user must otherwise exercise when deciding which specific area(s) and/or specific location(s) within the cooking chamber of the grill the above-described conventional textual and/or graphical user notifications associated with certain food movement steps of the cook program might apply to. The disclosed methods and apparatus accordingly improve the overall quality of the cooking experience associated with preparing an item of food utilizing a cook program, and also provide a user experience that is improved relative to that provided by known cook program implementations.

The above-identified features as well as other advantageous features of example methods and apparatus for presenting location-based food movement notifications in connection with cook programs of grills as disclosed herein are further described below in connection with the figures of the application. As used herein in a mechanical context, the term “configured” means sized, shaped, arranged, structured, oriented, positioned, and/or located. For example, in the context of a first object configured to fit within a second object, the first object is sized, shaped, arranged, structured, oriented, positioned, and/or located to fit within the second object. As used herein in an electrical and/or computing context, the term “configured” means arranged, structured, and/or programmed. For example, in the context of a controller configured to perform a specified operation, the controller is arranged, structured, and/or programmed (e.g., based on machine-readable instructions) to perform the specified operation. As used herein, the phrase “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, the term “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

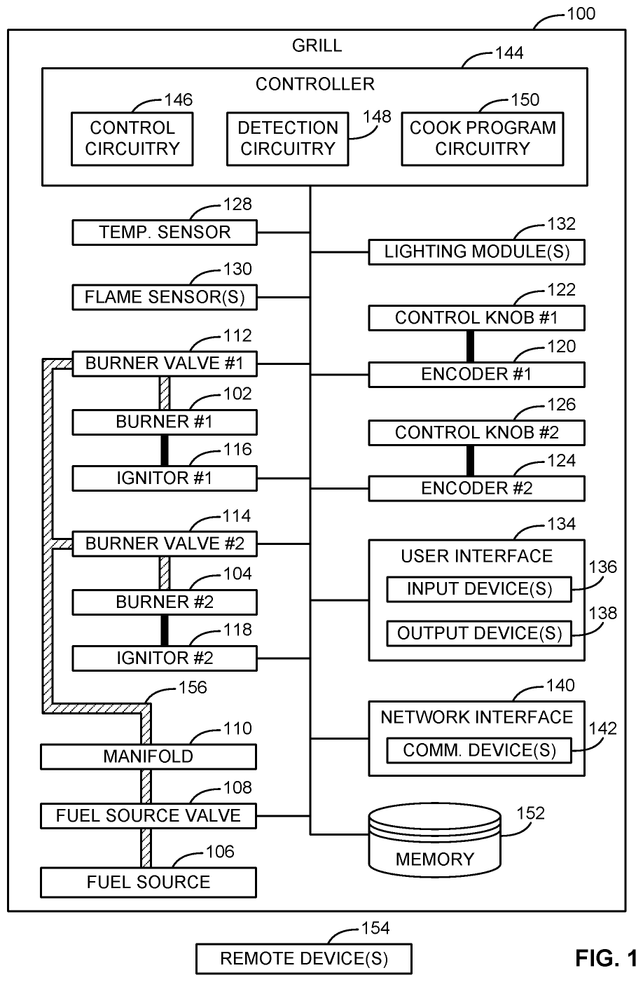

FIG. 1 is a block diagram of an example grill 100 constructed in accordance with the teachings of this disclosure. The grill 100 of FIG. 1 is a gas grill including a plurality of burners. In other examples, the grill 100 can be implemented as a different type of grill having a controllable heat source (e.g., a pellet grill, an electric grill, etc.). In the illustrated example of FIG. 1, the grill 100 includes an example first burner 102 and an example second burner 104. In other examples, the grill 100 can include one or more other burner(s) (e.g., a third burner, a fourth burner, a fifth burner, etc.) in addition to the first burner 102 and the second burner 104 shown and described in connection with FIG. 1. The first burner 102 and the second burner 104 of FIG. 1 are each constructed as a burner tube (e.g., a linear burner tube) including a gas inlet for receiving a flow of combustible gas, and further including a plurality of apertures configured to emit flames generated in response to ignition of the gas flowing into and/or through the burner tube.

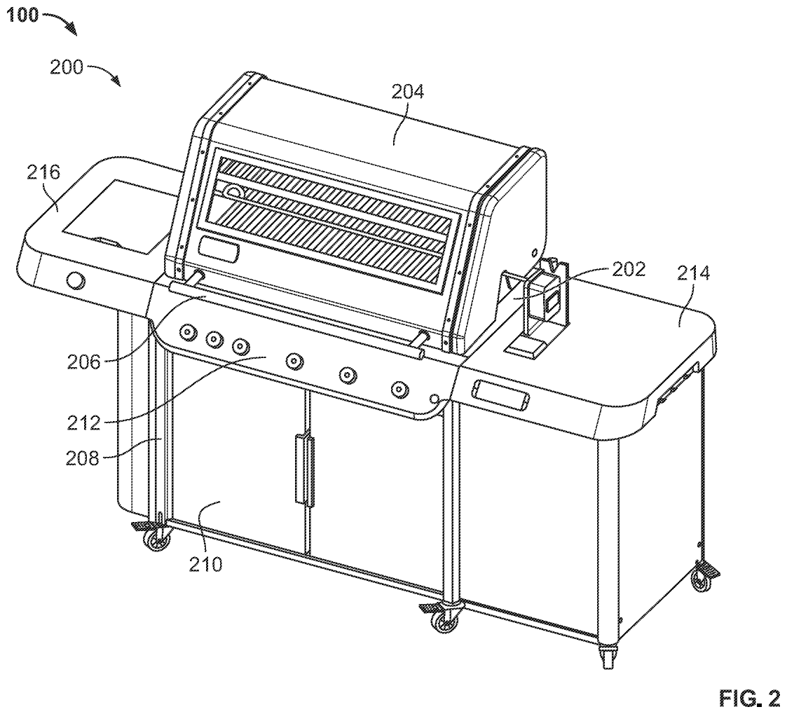

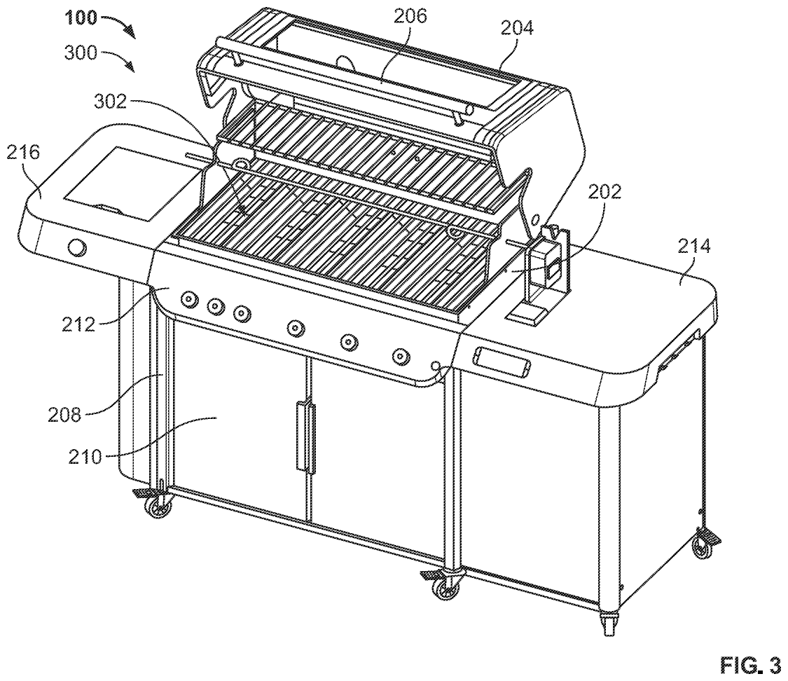

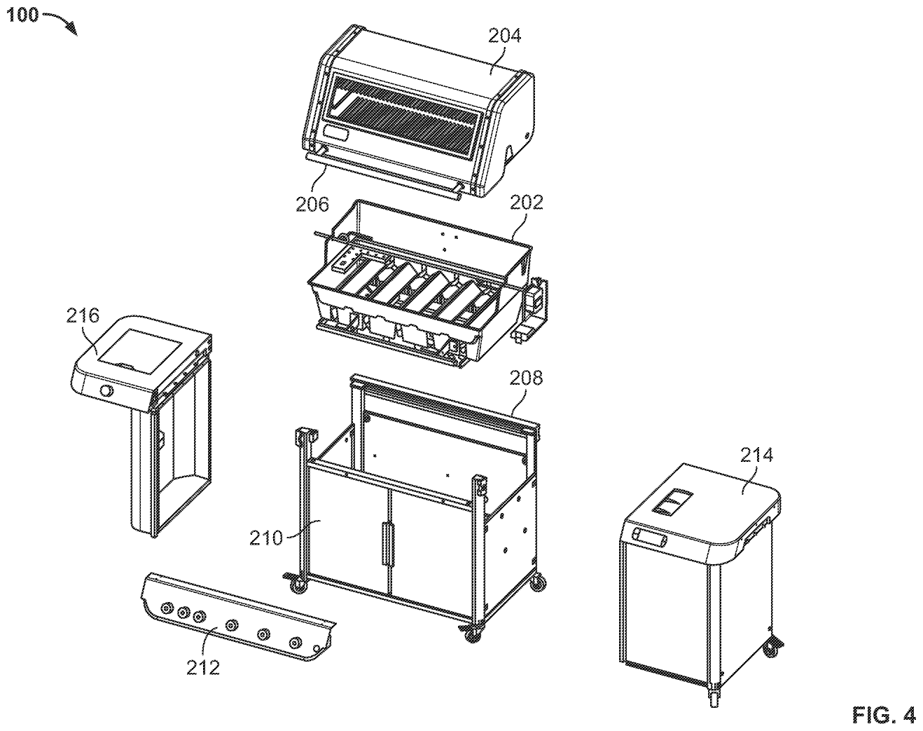

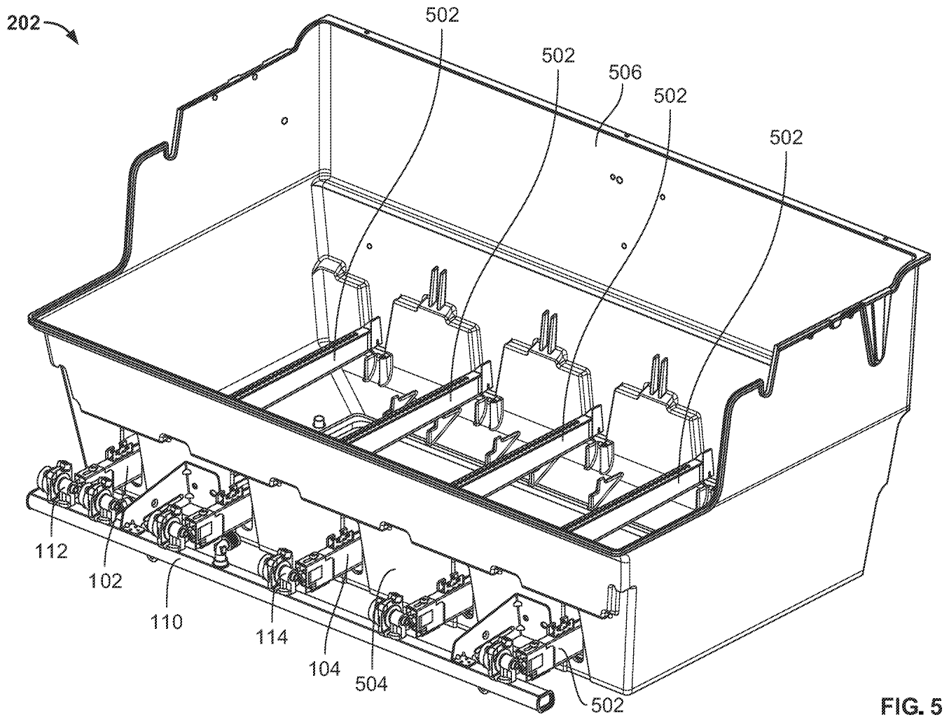

FIG. 2 is a perspective view of an example implementation of the grill 100 of FIG. 1, with an example lid 204 of the grill 100 shown in an example closed position 200 relative to an example cookbox 202 of the grill 100. FIG. 3 is a perspective view of the implementation of the grill 100 shown in FIG. 2, with the lid 204 of the grill 100 shown in an example open position 300 relative to the cookbox 202 of the grill 100. FIG. 4 is an exploded view of the implementation of the grill 100 shown in FIGS. 2 and 3. FIG. 5 is a perspective view of the cookbox 202 of the implementation of the grill 100 shown in FIGS. 2-4.

The cookbox 202 of the grill 100 supports, carries, and/or houses the burners (e.g., the first burner 102 and the second burner 104) of the grill 100, with respective ones of the burners being spaced apart from one another within the cookbox 202. As shown in FIG. 5, the cookbox 202 supports, carries, and/or houses a total of five example burners 502 (e.g., including the first burner 102 and the second burner 104 of FIG. 1), with each of the five burners 502 being spaced apart from one another within the cookbox 202. In other examples, the cookbox 202 can support, carry, and/or house a different number (e.g., two, three, four, six, etc.) of burners 502. In the illustrated example of FIGS. 2-5, each of the burners 502 is constructed as a linear burner tube positioned in a front-to-rear orientation within the cookbox 202 (e.g., extending from a front wall 504 of the cookbox 202 to a rear wall 506 of the cookbox 202). In other examples, one or more of the burner(s) 502 can have a different shape (e.g., a non-linear shape such as a P-tube), and/or can have a different orientation (e.g., a left-to-right orientation) within the cookbox 202. It should accordingly be understood that the cookbox configuration shown in FIGS. 2-5 is but one example of a cookbox 202 that can be implemented as part of the grill 100 of FIG. 1.

The lid 204 of the grill 100 is configured to cover and/or enclose the cookbox 202 of the grill 100 when the lid is in a closed position (e.g., the closed position 200 of FIG. 2). In the illustrated example of FIGS. 2-4, the lid 204 is movably (e.g., pivotally) coupled to the cookbox 202 such that the lid 204 can be moved (e.g., pivoted) relative to the cookbox 202 between a closed position (e.g., the closed position 200 of FIG. 2) and an open position (e.g., the open position 300 of FIG. 3). In other examples, the lid 204 of the grill 100 can instead be removably positioned on the cookbox 202 of the grill 100 without there being any direct mechanical coupling between the lid 204 and the cookbox 202. In some such other examples, the lid 204 can be movably (e.g., pivotally) coupled to one or more structure(s) of the grill 100 other than the cookbox 202. For example, the lid 204 can be movably (e.g., pivotally) coupled to a frame, to a cabinet, and/or to one or more side table(s) of the grill 100. Movement of the lid 204 of the grill 100 between the closed position 200 shown in FIG. 2 and the open position 300 shown in FIG. 3 can be facilitated via user interaction with an example handle 206 of the grill 100 that is coupled to the lid 204.

In the illustrated example of FIGS. 2-4, the cookbox 202 and the lid 204 of the grill 100 collectively define an example cooking chamber 302 configured to cook one or more item(s) of food. The cooking chamber 302 of the grill 100 becomes accessible to a user of the grill 100 when the lid 204 of the grill 100 is in the open position 300 shown in FIG. 3. Conversely, the cooking chamber 302 of the grill 100 is generally inaccessible to the user of the grill 100 when the lid 204 of the grill 100 is in the closed position 200 shown in FIG. 2. User access to the cooking chamber 302 of the grill 100 may periodically become necessary, for example, to add an item of food to the cooking chamber 302 (e.g., at or toward the beginning of a cook), to remove an item of food from the cooking chamber 302 (e.g., at or toward the end of a cook), and/or to flip, rotate, relocate, or otherwise move an item of food within the cooking chamber 302 (e.g., during the middle of a cook).

Food items contained within the cooking chamber 302 may be supported by an example cooking grate 304 located within the cooking chamber 302, as generally shown in FIG. 3. The cooking grate 304 of FIG. 3 can be implemented by any number(s), any type(s), and/or any configuration(s) of cooking grate(s) configured to occupy the cooking chamber 302. The cooking grate 304 is configured to support and/or carry one or more item(s) of food to be warmed and/or cooked by one or more of the burner(s) 502 of the grill 100. As shown in FIGS. 3-5, the cooking grate 304 includes one or more portion(s) and/or area(s) that is/are located directly over and/or directly above one or more of the burner(s) 502 of the grill 100, as well as one or more portion(s) and/or area(s) that is/are not located directly over and/or directly above any of the burners 502 of the grill 100.

As further shown in FIGS. 2-4, the grill 100 includes an example frame 208 that supports the cookbox 202 of the grill 100. In the illustrated example of FIGS. 2-4, the frame 208 forms an example cabinet 210 within which one or more component(s) of the grill 100 can be housed and/or stored. In other examples, the cabinet 210 of the grill 100 can be omitted in favor of an open-space configuration of the frame 208. As further shown in FIGS. 2-4, the grill 100 includes an example control panel 212 located along the front portion of the cookbox 202, the frame 208, and/or the cabinet 210 of the grill 100, an example first side table 214 located on a first side (e.g., a right side) of the cookbox 202, the frame 208, and/or the cabinet 210 of the grill 100, and an example second side table 216 located on a second side (e.g., a left side) of the cookbox 202, the frame 208, and/or the cabinet 210 of the grill 100. Various components of the grill 100 of FIG. 1 described herein can be supported by, carried by, housed by, mounted to, and/or otherwise coupled to at least one of the cookbox 202, the lid 204, the handle 206, the frame 208, the cabinet 210, the control panel 212, the first side table 214, and/or the second side table 216 of the grill 100.

Returning to the illustrated example of FIG. 1, the grill 100 of FIG. 1 further includes an example fuel source 106, an example fuel source valve 108, an example manifold 110, an example first burner valve 112, an example second burner valve 114, an example first ignitor 116, an example second ignitor 118, an example first encoder 120, an example first control knob 122, an example second encoder 124, an example second control knob 126, an example temperature sensor 128, one or more example flame sensor(s) 130, one or more example lighting module(s) 132, an example user interface 134 (e.g., including one or more example input device(s) 136 and one or more example output device(s) 138), an example network interface 140 (e.g., including one or more example communication device(s) 142), an example controller 144 (e.g., including example control circuitry 146, example detection circuitry 148, and example cook program circuitry 150), and an example memory 152. The grill 100 of FIG. 1 is configured to communicate (e.g., wirelessly communicate) with one or more example remote device(s) 154, as further described below.

The grill 100 of FIG. 1 includes a control system for controlling, managing, performing, and/or otherwise carrying out one or more operation(s) of the grill 100 including, for example, for presenting one or more food movement notification(s) in connection with one or more cook program(s) implemented via the grill 100. In the illustrated example of FIG. 1, the control system of the grill 100 includes the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), the controller 144 (e.g., including the control circuitry 146, the detection circuitry 148, and the cook program circuitry 150), and the memory 152. In other examples, one or more of the aforementioned components of the grill 100 can be omitted from the control system of the grill 100. For example, the fuel source valve 108 can be omitted from the control system of the grill 100 in instances where the fuel source valve 108 is not configured to be electrically controlled and/or electrically actuated by the controller 144, with the fuel source valve 108 instead being configured only for manual control and/or manual actuation. In still other examples, the control system of the grill 100 can further include the remote device(s) 154 that are configured to communicate (e.g., wirelessly communicate) with the grill 100.

The control system of the grill 100 of FIG. 1 is powered and/or operated by a power source. For example, the electrical components that form the control system of the grill 100 can be powered and/or operated by DC power supplied via one or more on-board or connected batteries of the grill 100. As another example, the electrical components that form the control system of the grill 100 can alternatively be powered and/or operated by AC power supplied via household electricity or wall power to which the grill 100 is connected. The grill 100 includes a power button (e.g., a power switch) that is configured to enable (e.g., power on) or disable (e.g., power off) the control system of the grill 100 in response to the power button being manually actuated by a user of the grill 100.

The grill 100 of FIG. 1 further includes an example gas train 156 that extends from the fuel source 106 to the manifold 110 of the grill 100, and from the manifold 110 to respective ones of the first burner 102 and the second burner 104 of the grill 100. The gas train 156 can be implemented via one ore more conduit(s) (e.g., one or more rigid or flexible pipe(s), tube(s), etc.) that are configured to carry combustible gas from the fuel source 106 to the first burner 102 and/or the second burner 104 of the grill 100. In some examples, the fuel source 106 is implemented as a fuel tank (e.g., a propane tank) containing combustible gas. In such examples, the fuel source 106 will typically be located partially or fully within the cabinet 210 of the grill 100, partially or fully within a spatial footprint formed by the frame 208 of the grill 100, below the cookbox 202 of the grill 100 and partially or fully within a spatial footprint formed by the cookbox 202 of the grill 100, or below the cookbox 202 of the grill 100 and partially or fully within a spatial footprint formed by the first side table 214 or the second side table 216 of the grill 100. In other examples, the fuel source 106 can instead be implemented as a piped (e.g., household) natural gas line that provides an accessible flow of combustible gas.

The fuel source valve 108 of FIG. 1 is coupled to and operatively positioned within the gas train 156 between the fuel source 106 and the manifold 110 of the grill 100. The fuel source valve 108 is configured to be movable between a closed position that prevents gas contained within the fuel source 106 from flowing into the manifold 110, and an open position that enables gas contained within the fuel source 106 to flow from the fuel source 106 into the manifold 110. In the illustrated example of FIG. 1, the fuel source valve 108 is operatively coupled to (e.g., in electrical communication with) the controller 144 of the grill 100, with the fuel source valve 108 being implemented as a controllable electric valve (e.g., a solenoid valve) that is configured to transition from the closed position to the open position, and vice-versa, in response to instructions, commands, and/or signals (e.g., a supply of current) generated by the controller 144. In other examples, the fuel source valve 108 can instead be implemented as a valve having a knob or a lever operatively coupled (e.g., mechanically coupled) thereto, with the knob or the lever being configured to be electrically actuated (e.g., via a motor) in response to instructions, commands, and/or signals generated by the controller 144 of the grill 100. In still other examples, the fuel source valve 108 may have no electrically-controllable components, in which case actuation of the fuel source valve 108 from the closed position to the open position, and vice-versa, occurs in response to a user of the grill 100 manually actuating a knob or a lever that is operatively coupled (e.g., mechanically coupled) to the fuel source valve 108.

The first burner valve 112 of FIG. 1 is coupled to and operatively positioned within the gas train 156 between the manifold 110 and the first burner 102 of the grill 100. In some examples, a gas inlet of the first burner valve 112 is located within the manifold 110, and a gas outlet of the first burner valve 112 is located within the first burner 102. The first burner valve 112 is configured to be movable between a closed position that prevents gas contained within the manifold 110 from flowing into the first burner 102, and an open position that enables gas contained within the manifold 110 to flow from the manifold 110 into the first burner 102. In the illustrated example of FIG. 1, the first burner valve 112 is operatively coupled to (e.g., in electrical communication with) the controller 144 of the grill 100, with the first burner valve 112 being is implemented as a controllable electric valve (e.g., a solenoid valve) that is configured to transition from the closed position to the open position, and vice-versa, in response to instructions, commands, and/or signals (e.g., a supply of current) generated by the controller 144. In some examples, the first burner valve 112 is controllable to any position (e.g., infinite position control) between the above-described closed position (e.g., fully closed) and the above-described open position (e.g., fully open). In such examples, the first burner valve 112 of FIG. 1 may be controlled to various positions to achieve different specified temperatures (e.g., different setpoint temperatures) within the cooking chamber 302 of the grill 100, as may be required by the various ordered steps, instructions, and/or operations of one or more selectable cook program(s) to be implemented via the control system of the grill 100.

The second burner valve 114 of FIG. 1 is coupled to and operatively positioned within the gas train 156 between the manifold 110 and the second burner 104 of the grill 100. In some examples, a gas inlet of the second burner valve 114 is located within the manifold 110, and a gas outlet of the second burner valve 114 is located within the second burner 104. The second burner valve 114 is configured to be movable between a closed position that prevents gas contained within the manifold 110 from flowing into the second burner 104, and an open position that enables gas contained within the manifold 110 to flow from the manifold 110 into the second burner 104. In the illustrated example of FIG. 1, the second burner valve 114 is operatively coupled to (e.g., in electrical communication with) the controller 144 of the grill 100, with the second burner valve 114 being implemented as a controllable electric valve (e.g., a solenoid valve) that is configured to transition from the closed position to the open position, and vice-versa, in response to instructions, commands, and/or signals (e.g., a supply of current) generated by the controller 144. In some examples, the second burner valve 114 is controllable to any position (e.g., infinite position control) between the above-described closed position (e.g., fully closed) and the above-described open position (e.g., fully open). In such examples, the second burner valve 114 of FIG. 1 may be controlled to various positions to achieve different specified temperatures (e.g., different setpoint temperatures) within the cooking chamber 302 of the grill 100, as may be required by the various ordered steps, instructions, and/or operations of one or more selectable cook program(s) to be implemented via the control system of the grill 100.

As described above, the first burner valve 112 and the second burner valve 114 of FIG. 1 respectively differ from known burner valves of conventional gas grills in that neither the first burner valve 112 nor the second burner valve 114 includes a stem that is mechanically coupled to a user-accessible control knob of the grill, whereby the control knob traditionally facilitates manual control and/or manual actuation of the operable position of the burner valve. The first burner valve 112 and the second burner valve 114 of FIG. 1 are instead only controllable and/or actuatable via the “control-by-wire” functionality further described herein.

The first ignitor 116 of FIG. 1 is mechanically coupled and/or operatively positioned relative to the first burner 102 of the grill 100. More specifically, the first ignitor 116 is located adjacent the first burner 102 at a position that enables the first ignitor 116 to ignite combustible gas as the gas emanates from within the first burner 102 via apertures formed in the first burner 102. The first ignitor 116 of FIG. 1 is operatively coupled to (e.g., in electrical communication with) the controller 144 of the grill 100, with the first ignitor 116 being configured to generate sparks (e.g., via a spark electrode of the first ignitor 116) and/or otherwise induces ignition of the combustible gas in response to an instruction, a command, and/or a signal generated by the controller 144.

The second ignitor 118 of FIG. 1 is mechanically coupled and/or operatively positioned relative to the second burner 104 of the grill 100. More specifically, the second ignitor 118 is located adjacent the second burner 104 at a position that enables the second ignitor 118 to ignite combustible gas as the gas emanates from within the second burner 104 via apertures formed in the second burner 104. The second ignitor 118 of FIG. 1 is operatively coupled to (e.g., in electrical communication with) the controller 144 of the grill 100, with the second ignitor 118 being configured to generate sparks (e.g., via a spark electrode of the second ignitor 118) and/or otherwise induces ignition of the combustible gas in response to an instruction, a command, and/or a signal generated by the controller 144.

In some examples, the first ignitor 116 and/or the second ignitor 118 of FIG. 1 can respectively be structured, configured, and/or implemented as one of the various ignitors described in U.S. patent application Ser. No. 17/144,038, filed on Jan. 7, 2021. In such examples, the first ignitor 116 and/or the second ignitor 118 of FIG. 1 can respectively be mechanically coupled to a corresponding one of the first burner 102 and/or the second burner 104 of the grill 100 via a ceramic harness as described in U.S. patent application Ser. No. 17/144,038. The entirety of U.S. patent application Ser. No. 17/144,038 is hereby incorporated by reference herein.

The first encoder 120 of FIG. 1 is mechanically coupled to the first control knob 122 of FIG. 1 and operatively coupled to (e.g., in electrical communication with) the controller 144 of FIG. 1. In this regard, the first encoder 120 of FIG. 1 is implemented as a rotary encoder having a rotatable portion (e.g., a rotatable shaft) to which the first control knob 122 is mechanically coupled. The rotatable portion of the first encoder 120 can be rotated relative to a fixed portion of the first encoder 120 via user interaction with the first control knob 122 (e.g., manual rotation of the first control knob 122). The fixed portion of the first encoder 120 includes one or more sensor(s) that is/are configured to sense, measure, and/or detect the relative angular position of the rotatable portion and/or the relative angular position of the first control knob 122. Data, information, and/or signals that is/are sensed, measured, and/or detected by the sensor(s) of the first encoder 120 can be transmitted directly to the controller 144 of FIG. 1, and/or can be transmitted to and stored in the memory 152 of FIG. 1. In some examples, the sensor(s) of the first encoder 120 is/are further configured to sense, measure, and/or detect a translational movement of the rotatable portion relative to the fixed portion of the first encoder 120, as may occur in response to a user of the grill 100 pushing or pressing on the first control knob 122 in a direction that is generally perpendicular to the direction(s) in which the first control knob 122 is configured to be rotated by the user.

In some examples, the first encoder 120 of FIG. 1 is mounted to the control panel 212 of the grill 100 (e.g., to a printed circuit board of the control panel 212) such that the first encoder 120 is located at a position on the control panel 212 that would conventionally be occupied by a stem of a burner valve that corresponds to the first burner valve 112 of FIG. 1. Such an example further facilitates locating the first control knob 122 of FIG. 1 at a position on or along the control panel 212 that would conventionally be occupied by a control knob that is mechanically coupled to the stem of the burner valve that corresponds to the first burner valve 112 of FIG. 1. Thus, the first control knob 122 is spatially aligned (e.g., in front-to-rear and/or top-to-bottom alignment along a vertical plane) with the first encoder 120, the first burner valve 112, and/or the first burner 102 of FIG. 1, as well as an area and/or portion of the cooking grate 304 that is located directly above and/or directly over the first burner 102 of FIG. 1. While the first control knob 122 of FIG. 1 may accordingly be located at a position on or along the control panel 212 of the grill 100 that mimics the position at which a traditional control knob is located, user actuation (e.g., manual rotation) of the first control knob 122 of FIG. 1 provides a response that differs greatly from that provided by user actuation (e.g., manual rotation) of a traditional control knob.

For example, conventional multi-burner gas grills typically include a plurality of control knobs (e.g., located on or along a control panel of the grill), with each control knob being physically associated with a corresponding one of the burners of the gas grill by virtue of (1) a first mechanical connection existing between the control knob and a stem of a corresponding burner valve (e.g., such that rotation of the control knob by a user of the grill opens, closes, or otherwise adjusts the position of the burner valve), and (2) a second mechanical connection existing between the burner valve and the corresponding burner. By contrast, the grill 100 of FIG. 1 implements a “control-by-wire” architecture that eliminates the first of the aforementioned mechanical connections in favor of (1) a mechanical connection existing between the first control knob 122 of FIG. 1 and the first encoder 120 of FIG. 1, (2) a first electrical connection existing between the first encoder 120 of FIG. 1 and the controller 144 and/or the memory 152 of FIG. 1, and (3) a second electrical connection existing between the controller 144 of FIG. 1 and the first burner valve 112 of FIG. 1.

Although the first control knob 122 of FIG. 1 is not mechanically coupled to the first burner valve 112 of FIG. 1, rotation of the first control knob 122 by a user of the grill 100 can nonetheless cause the first burner valve 112 to open, close, or otherwise adjust its position. In this regard, the controller 144 of FIG. 1 is configured to interpret different rotational positions of the first control knob 122 of FIG. 1 (e.g., as sensed, measured, and/or detected by the first encoder 120 of FIG. 1) as being indicative of correlated user requests associated with different operational states (e.g., ignite, high, medium, low, or off) of the first burner 102 of FIG. 1. For example, in response to determining that the first control knob 122 has been positioned at a relative angle of negative one hundred eighty degrees (−180°), the controller 144 may interpret the determined rotational position as a user request that the first burner 102 operate in a “medium” state. To satisfy the user request indicated by the determined rotational position of the first control knob 122, the controller 144 may instruct, command, and/or signal the first burner valve 112 of FIG. 1 to assume a first corresponding target position, such as a partially open (e.g., 50% open) position that facilitates a “medium” flow of gas through the first burner valve 112 and into the first burner 102, thereby effecting the “medium” operational state of the first burner 102.

As another example, in response to determining that the first control knob 122 has been positioned at a relative angle of negative ninety degrees (−90°), the controller 144 may interpret the determined rotational position as a user request that the first burner 102 operate in a “high” state. To satisfy the user request indicated by the determined rotational position of the first control knob 122, the controller 144 may instruct, command, and/or signal the first burner valve 112 of FIG. 1 to assume a second corresponding target position, such as a fully open (e.g., 100% open) position that facilitates a “high” flow of gas through the first burner valve 112 and into the first burner 102, thereby effecting the “high” operational state of the first burner 102. As yet another example, in response to determining that the first control knob 122 has been positioned at a relative angle of zero degrees (0°), the controller 144 may interpret the determined rotational position as a user request that the first burner 102 be placed in an “off” state. To satisfy the user request indicated by the determined rotational position of the first control knob 122, the controller 144 may instruct, command, and/or signal the first burner valve 112 of FIG. 1 to assume a third corresponding target position, such as a fully closed (e.g., 0% open, or 100% closed) position that prevents any flow of gas through the first burner valve 112 and into the first burner 102, thereby effecting the “off” state of the first burner 102.

Correlation data (e.g., a correlation table) establishing and/or defining one or more correlation(s) and/or relationship(s) between one or more rotational position(s) of the first encoder 120 and/or the first control knob 122 of the grill 100 of FIG. 1 on the one hand, and one or more target position(s) of the first burner valve 112 of the grill of FIG. 1 on the other hand may be stored in the memory 152 of the grill 100 of FIG. 1. Such correlation data may be accessed from the memory 152 by the controller 144 of the grill 100 of FIG. 1 in the course of the controller 144 determining a target position for the first burner valve 112 (e.g., a position to which the controller 144 is to instruct, command, and/or otherwise cause the first burner valve 112 to move to) based on a detected and/or determined rotational position of the first encoder 120 and/or the first control knob 122 of the grill 100 of FIG. 1, as further described below.

The second encoder 124 of FIG. 1 is mechanically coupled to the second control knob 126 of FIG. 1 and operatively coupled to (e.g., in electrical communication with) the controller 144 of FIG. 1. In this regard, the second encoder 124 of FIG. 1 is implemented as a rotary encoder having a rotatable portion (e.g., a rotatable shaft) to which the second control knob 126 is mechanically coupled. The rotatable portion of the second encoder 124 can be rotated relative to a fixed portion of the second encoder 124 via user interaction with the second control knob 126 (e.g., manual rotation of the second control knob 126). The fixed portion of the second encoder 124 includes one or more sensor(s) that is/are configured to sense, measure, and/or detect the relative angular position of the rotatable portion and/or the relative angular position of the second control knob 126. Data, information, and/or signals that is/are sensed, measured, and/or detected by the sensor(s) of the second encoder 124 can be transmitted directly to the controller 144 of FIG. 1, and/or can be transmitted to and stored in the memory 152 of FIG. 1. In some examples, the sensor(s) of the second encoder 124 is/are further configured to sense, measure, and/or detect a translational movement of the rotatable portion relative to the fixed portion of the second encoder 124, as may occur in response to a user of the grill 100 pushing or pressing on the second control knob 126 in a direction that is generally perpendicular to the direction(s) in which the second control knob 126 is configured to be rotated by the user.

In some examples, the second encoder 124 of FIG. 1 is mounted to the control panel 212 of the grill 100 (e.g., to a printed circuit board of the control panel 212) such that the second encoder 124 is located at a position on the control panel 212 that would conventionally be occupied by a stem of a burner valve that corresponds to the second burner valve 114 of FIG. 1. Such an example further facilitates locating the second control knob 126 of FIG. 1 at a position on or along the control panel 212 that would conventionally be occupied by a control knob that is mechanically coupled to the stem of the burner valve that corresponds to the second burner valve 114 of FIG. 1. Thus, the second control knob 126 is spatially aligned (e.g., in front-to-rear and/or top-to-bottom alignment along a vertical plane) with the second encoder 124, the second burner valve 114, and/or the second burner 104 of FIG. 1, as well as an area and/or portion of the cooking grate 304 that is located directly above and/or directly over the second burner 104 of FIG. 1. While the second control knob 126 of FIG. 1 may accordingly be located at a position on or along the control panel 212 of the grill 100 that mimics the position at which a traditional control knob is located, user actuation (e.g., manual rotation) of the second control knob 126 of FIG. 1 provides a response that differs greatly from that provided by user actuation (e.g., manual rotation) of a traditional control knob.

For example, conventional multi-burner gas grills typically include a plurality of control knobs (e.g., located on or along a control panel of the grill), with each control knob being physically associated with a corresponding one of the burners of the gas grill by virtue of (1) a first mechanical connection existing between the control knob and a stem of a corresponding burner valve (e.g., such that rotation of the control knob by a user of the grill opens, closes, or otherwise adjusts the position of the burner valve), and (2) a second mechanical connection existing between the burner valve and the corresponding burner. By contrast, the grill 100 of FIG. 1 implements a “control-by-wire” architecture that eliminates the first of the aforementioned mechanical connections in favor of (1) a mechanical connection existing between the second control knob 126 of FIG. 1 and the second encoder 124 of FIG. 1, (2) a first electrical connection existing between the second encoder 124 of FIG. 1 and the controller 144 and/or the memory 152 of FIG. 1, and (3) a second electrical connection existing between the controller 144 of FIG. 1 and the second burner valve 114 of FIG. 1.

Although the second control knob 126 of FIG. 1 is not mechanically coupled to the second burner valve 114 of FIG. 1, rotation of the second control knob 126 by a user of the grill 100 can nonetheless cause the second burner valve 114 to open, close, or otherwise adjust its position. In this regard, the controller 144 of FIG. 1 is configured to interpret different rotational positions of the second control knob 126 of FIG. 1 (e.g., as sensed, measured, and/or detected by the second encoder 124 of FIG. 1) as being indicative of correlated user requests associated with different operational states (e.g., ignite, high, medium, low, or off) of the second burner 104 of FIG. 1. For example, in response to determining that the second control knob 126 has been positioned at a relative angle of negative one hundred eighty degrees (−180°), the controller 144 may interpret the determined rotational position as a user request that the second burner 104 operate in a “medium” state. To satisfy the user request indicated by the determined rotational position of the second control knob 126, the controller 144 may instruct, command, and/or signal the second burner valve 114 of FIG. 1 to assume a first corresponding target position, such as a partially open (e.g., 50% open) position that facilitates a “medium” flow of gas through the second burner valve 114 and into the second burner 104, thereby effecting the “medium” operational state of the second burner 104.

As another example, in response to determining that the second control knob 126 has been positioned at a relative angle of negative ninety degrees (−90°), the controller 144 may interpret the determined rotational position as a user request that the second burner 104 operate in a “high” state. To satisfy the user request indicated by the determined rotational position of the second control knob 126, the controller 144 may instruct, command, and/or signal the second burner valve 114 of FIG. 1 to assume a second corresponding target position, such as a fully open (e.g., 100% open) position that facilitates a “high” flow of gas through the second burner valve 114 and into the second burner 104, thereby effecting the “high” operational state of the second burner 104. As yet another example, in response to determining that the second control knob 126 has been positioned at a relative angle of zero degrees (0°), the controller 144 may interpret the determined rotational position as a user request that the second burner 104 be placed in an “off” state. To satisfy the user request indicated by the determined rotational position of the second control knob 126, the controller 144 may instruct, command, and/or signal the second burner valve 114 of FIG. 1 to assume a third corresponding target position, such as a fully closed (e.g., 0% open, or 100% closed) position that prevents any flow of gas through the second burner valve 114 and into the second burner 104, thereby effecting the “off” state of the second burner 104.

Correlation data (e.g., a correlation table) establishing and/or defining one or more correlation(s) and/or relationship(s) between one or more rotational position(s) of the second encoder 124 and/or the second control knob 126 of the grill 100 of FIG. 1 on the one hand, and one or more target position(s) of the second burner valve 114 of the grill 100 of FIG. 1 on the other hand may be stored in the memory 152 of the grill 100 of FIG. 1. Such correlation data may be accessed from the memory 152 by the controller 144 of the grill 100 of FIG. 1 in the course of the controller 144 determining a target position for the second burner valve 114 (e.g., a position to which the controller 144 is to instruct, command, and/or otherwise cause the second burner valve 114 to move to) based on a detected and/or determined rotational position of the second encoder 124 and/or the second control knob 126 of the grill 100 of FIG. 1, as further described below.

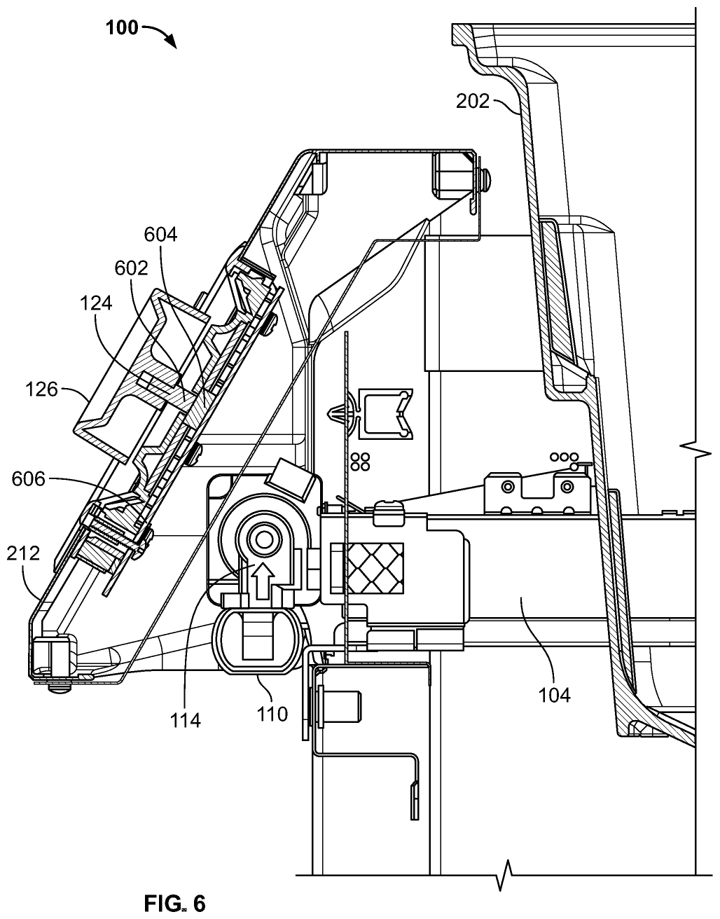

FIG. 6 is a partial cross-sectional view of the implementation of the grill 100 shown in FIGS. 2-4. As shown in FIG. 6, the second encoder 124 of the grill 100 is implemented as a rotary encoder having an example rotatable portion 602 (e.g., a rotatable shaft) to which the second control knob 126 of the grill 100 is mechanically coupled. The rotatable portion 602 of the second encoder 124 can be rotated relative to an example fixed portion 604 of the second encoder 124 via user interaction with the second control knob 126 (e.g., manual rotation of the second control knob 126). The fixed portion 604 of the second encoder 124 includes one or more sensor(s) that is/are configured to sense, measure, and/or detect the relative angular position of the rotatable portion 602 and/or the relative angular position of the second control knob 126. Data, information, and/or signals that is/are sensed, measured, and/or detected by the sensor(s) of the second encoder 124 can be transmitted directly to the controller 144 of FIG. 1, and/or can be transmitted to and stored in the memory 152 of FIG. 1. In some examples, the sensor(s) of the second encoder 124 is/are further configured to sense, measure, and/or detect a translational movement of the rotatable portion 602 relative to the fixed portion 604 of the second encoder 124, as may occur in response to a user of the grill 100 pushing or pressing on the second control knob 126 in a direction that is generally perpendicular to the direction(s) in which the second control knob 126 is configured to be rotated by the user.

In the illustrated example of FIG. 6, the fixed portion 604 of the second encoder 124 of the grill 100 is mounted to an example printed circuit board 606 of the control panel 212 of the grill 100, with the second encoder 124 being located at a position on the control panel 212 that would conventionally be occupied by a stem of a burner valve that corresponds to the second burner valve 114 of the grill 100. Such an example further facilitates locating the second control knob 126 of the grill 100 at a position on or along the control panel 212 that would conventionally be occupied by a control knob that is mechanically coupled to the stem of the burner valve that corresponds to the second burner valve 114 of the grill 100. In this regard, FIG. 6 illustrates the second control knob 126 in spatial alignment (e.g., in front-to-rear and/or top-to-bottom alignment along a vertical plane) with the second encoder 124, the second burner valve 114, and the second burner 104 of the grill 100. As further shown in FIG. 6, the second control knob 126 of the grill 100 is not mechanically coupled to the second burner valve 114 of the grill 100. Nor is any portion of the second encoder 124 of the grill 100 mechanically coupled to the second burner valve 114 of the grill 100. Instead, a “control-by-wire” architecture exists in relation to the second control knob 126 of the grill 100 and the second burner valve 114 of the grill 100, with such “control-by-wire” architecture being facilitated via the implementation of the second encoder 124 as described above.

Returning to the illustrated example of FIG. 1, the temperature sensor 128 of FIG. 1 senses, measures, and/or detects the temperature within the cooking chamber 302 of the grill 100. In some examples, the temperature sensor 128 can be implemented by and/or as a thermocouple coupled to either the cookbox 202 or the lid 204 of the grill 100, and positioned in and/or extending into the cooking chamber 302 of the grill 100. Data, information, and/or signals sensed, measured, and/or detected by the temperature sensor 128 of FIG. 1 can be of any quantity, type, form, and/or format. Data, information, and/or signals sensed, measured, and/or detected by the temperature sensor 128 of FIG. 1 can be transmitted directly to the controller 144 of FIG. 1, and/or can be transmitted to and stored in the memory 152 of FIG. 1.

The flame sensor(s) 130 of the grill 100 of FIG. 1 can be implemented by any number(s), any type(s), and/or any configuration(s) of flame sensor(s). The flame sensor(s) 130 is/are configured to sense, measure, and/or detect the presence and/or the absence of a flame emanating from the first burner 102 and/or the second burner 104 of the grill 100. In some examples, one or more of the flame sensor(s) 130 of the grill 100 can be structured, configured, and/or implemented as one of the various flame sensors described in U.S. patent application Ser. No. 17/144,038, filed on Jan. 7, 2021. The entirety of U.S. patent application Ser. No. 17/144,038 is hereby incorporated by reference herein. Data, information, and/or signals sensed, measured, and/or detected by the flame sensor(s) 130 of FIG. 1 can be of any quantity, type, form, and/or format. In some examples, data, information, and/or signals sensed, measured, and/or detected by the flame sensor(s) 130 of FIG. 1 can be transmitted directly to the controller 144 of FIG. 1, and/or can be transmitted to and stored in the memory 152 of FIG. 1.

The lighting module(s) 132 of the grill 100 of FIG. 1 can be implemented by any number(s), any type(s), and/or any configuration(s) of lighting module(s). The lighting module(s) 132 of FIG. 1 is/are configured to project light (e.g., emitted from one or more incandescent, halogen, or light-emitting diode (LED) light source(s) of the lighting module(s) 132) toward or away from one or more structure(s) of the grill 100 including, for example, the cookbox 202, the lid 204, the handle 206, the frame 208, the cabinet 210, the control panel 212, the first side table 214, and/or the second side table 216 of the grill 100. In some examples, one or more of the lighting module(s) 132 is/are mechanically coupled to (e.g., fixedly connected to) the grill 100. For example, one or more of the lighting module(s) 132 can be mounted to the cookbox 202, the lid 204, the handle 206, the frame 208, the cabinet 210, the control panel 212, the first side table 214, and/or the second side table 216 of the grill 100. In some such examples, the lighting module(s) 132 is/are mounted to a portion of the grill 100 that enables the light source(s) of the lighting module(s) 132 to be easily viewed by a user of the grill 100, such as a front portion of the cookbox 202, a front portion of the lid 204, a front portion of the handle 206, a front portion of the frame 208, a front portion of the cabinet 210, a front portion of the control panel 212, a front portion of the first side table 214, and/or a front portion of the second side table 216 of the grill 100. In sill other examples, the lighting module(s) 132 can instead be mounted to a portion of the grill 100 that enables the light source(s) of the lighting module(s) 132 to project toward, into, and/or onto the cooking chamber 302 of the grill 100, such as an interior portion of the cookbox 202, an interior portion of the lid 204, and/or an inwardly or downwardly facing portion of the handle 206 of the grill 100.

In some examples, one or more of the lighting module(s) 132 is/are preferably mounted to a front portion of the control panel 212 of the grill 100, with each such mounted lighting module 132 being spatially aligned (e.g., in front-to-rear and/or top-to-bottom alignment along a vertical plane) with a corresponding one of the control knob(s) (e.g., the first control knob 122 or the second control knob 126), a corresponding one of the encoder(s) (e.g., the first encoder 120 or the second encoder 124), a corresponding one of the burner valve(s) (e.g., the first burner valve 112 or the second burner valve 114), and/or a corresponding one of the burner(s) (e.g., the first burner 102 or the second burner 104) of the grill 100. In such examples, each such mounted lighting module 132 will also be spatially aligned (e.g., in front-to-rear and/or top-to-bottom alignment along a vertical plane) with a portion and/or an area of a corresponding one of the cooking grate(s) (e.g., a portion and/or an area of the cooking grate 304) that is located directly above and/or directly over the corresponding one of the burner(s) (e.g., the first burner 102 or the second burner 104).

One or more of the lighting module(s) 132 of the grill 100 of FIG. 1 can be implemented as a controllable electric lighting module having one or more light source(s) that is/are configured to transition from an off state (e.g., a non-light-projecting state of the light source(s) of the lighting module) to an on state (e.g., a light-projecting state of the light source(s) of the lighting module), and vice-versa, in response to instructions, commands, and/or signals (e.g., a supply of current) generated by the controller 144 of the grill 100. In some examples, one or more of the light source(s) of the lighting module(s) 132 may be instructed, commanded, and/or signaled (e.g., by the controller 144) to illuminate in a manner that causes the light source(s) to appear as being constantly lit (e.g., in a constant light-projecting state) over a duration of time. In other examples, one or more of the light source(s) of the lighting module(s) 132 may be instructed, commanded, and/or signaled (e.g., by the controller 144) to illuminate in a manner that causes the light source(s) to appear as being periodically lit and/or blinking (e.g., switching up and back between a light-projecting state and a non-light-projecting state) over a duration of time. In other examples, one or more of the light source(s) of the lighting module(s) 132 may be instructed, commanded, and/or signaled (e.g., by the controller 144) to cease illuminating such that the light source(s) appear as being constantly unlit (e.g., in a constant non-light-projecting state) over a duration of time. In other examples, one or more of the light source(s) of the lighting module(s) 132 may be instructed, commanded, and/or signaled (e.g., by the controller 144) to cease illuminating such that the light source(s) appear as being constantly unlit (e.g., in a constant non-light-projecting state) over a duration of time. The aforementioned illumination schemes (e.g., constantly lighting, pulsing, etc.) are example techniques by which the disclosed methods and apparatus can advantageously provide a user of the grill 100 with an intuitive “at-the-cookbox” visual identification (e.g., presented via one or more of the lighting module(s) 132 of the grill 100) of one or more area(s) and/or location(s) within the cooking chamber 302 of the grill 100 at which one or more associated food movement step(s) of a cook program being executed by the controller 144 of the grill 100 is/are to be performed.

In instances where one or more of the light source(s) of the lighting module(s) 132 is/are implemented as an LED, one or more of such LED(s) can be implemented as multi-color LED that can be instructed, commanded, and/or signaled (e.g., by the controller 144) to illuminate in different colors (e.g., white, red, blue, etc.) of the color spectrum. In some such examples, one or more of the multi-color LED(s) may be instructed, commanded, and/or signaled to illuminate in a first color (e.g., white) to indicate that the grill 100 is powered on, and a second color (e.g., red) to indicate an area and/or a location within the cooking chamber 302 of the grill 100 at which an associated food movement step of a cook program being executed by the controller 144 of the grill 100 is to be performed, as further described below. The aforementioned color schemes are other example techniques by which the disclosed methods and apparatus can advantageously provide a user of the grill 100 with an intuitive “at-the-cookbox” visual identification (e.g., presented via one or more of the lighting module(s) 132 of the grill 100) of one or more area(s) and/or location(s) within the cooking chamber 302 of the grill 100 at which one or more associated food movement step(s) of a cook program being executed by the controller 144 of the grill 100 is/are to be performed.

In some examples, one or more of the lighting module(s) 132 respectively include a plurality of light sources. In some examples, respective ones of the plurality of light sources of any one of the lighting module(s) 132 may be instructed, commanded, and/or signaled (e.g., by the controller 144) to illuminate according to a pattern that indicates a direction (e.g., to the left, to the right, etc.) within the cooking chamber 302 of the grill 100 in which at item of food located within the cooking chamber 302 is to be moved. In some examples, respective ones of the plurality of light sources of any one of the lighting module(s) 132 may be instructed, commanded, and/or signaled (e.g., by the controller 144) to illuminate according to a pattern that indicates a time (e.g., in two minutes, in one minute, etc.) at which an item of food is to be added to, removed from, and/or moved within the cooking chamber 302 of the grill 100. The aforementioned illumination patterns are example techniques by which the disclosed methods and apparatus can advantageously provide a user of the grill 100 with an intuitive “at-the-cookbox” visual identification (e.g., presented via one or more of the lighting module(s) 132 of the grill 100) of one or more direction(s) and/or time(s) in and/or at which one or more associated food movement step(s) of a cook program being executed by the controller 144 of the grill 100 is/are to be performed.

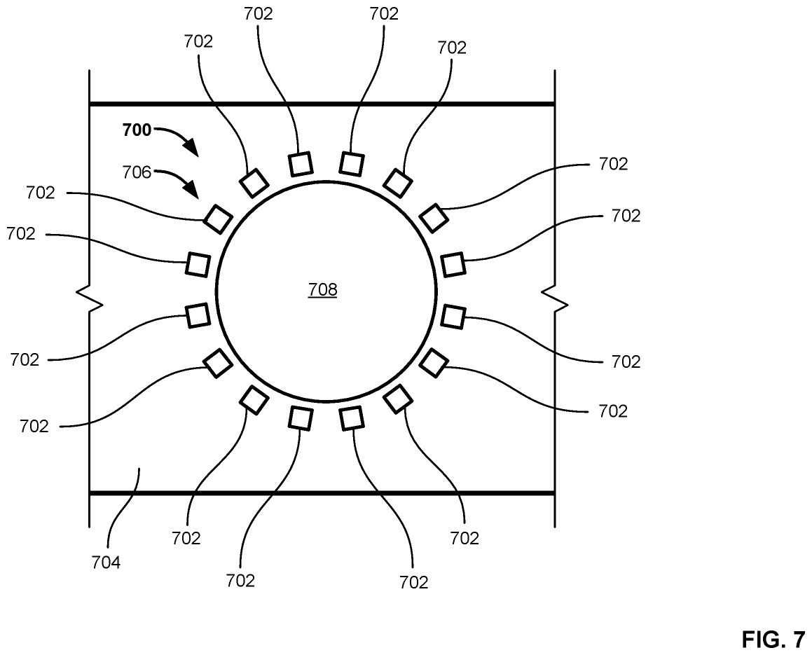

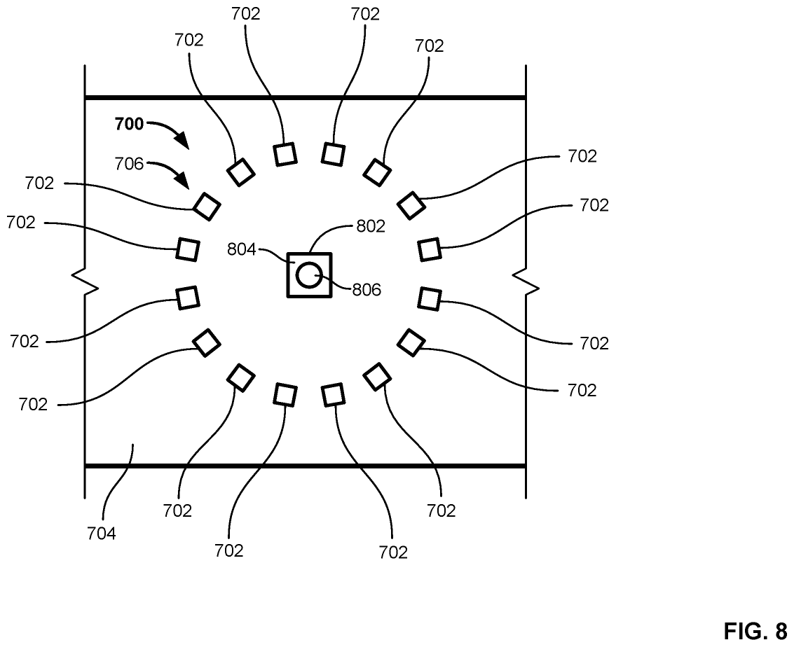

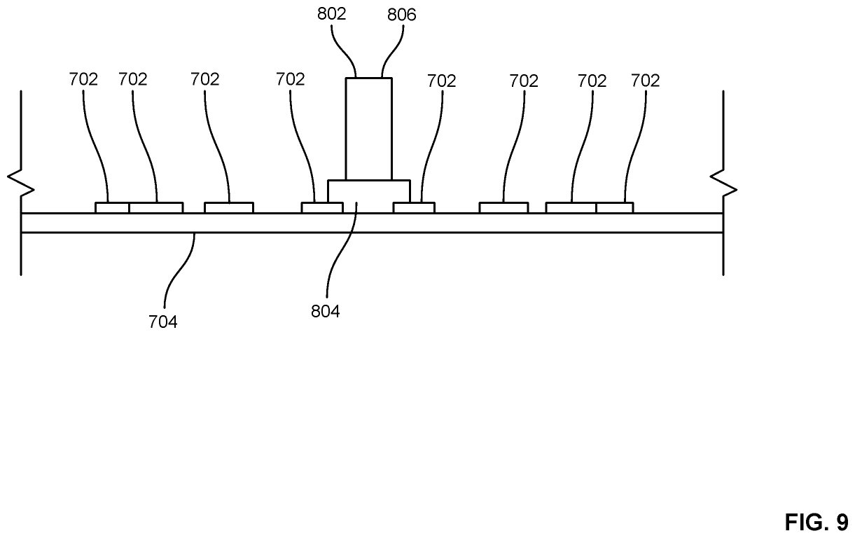

FIG. 7 a front view of an example lighting module 700 that can be implemented by or as one of the lighting module(s) 132 of FIG. 1. In the illustrated example of FIG. 7, the lighting module 700 includes a plurality of example LEDs 702 mounted to, positioned on, and/or otherwise located relative to an example printed circuit board 704 of a control panel of a grill (e.g., the control panel 212 of the grill 100 of FIGS. 2-4 and 6). As shown in FIG. 7, the LEDs 702 are configured as an example ring 706, with the ring 706 being concentrically positioned relative to an example control knob 708 that is also mounted to, positioned on, and/or otherwise located relative to the printed circuit board 704 of the control panel. The control knob 708 of FIG. 7 can be implemented by and or as the first control knob 122 or the second control knob 126 of FIG. 1 described above. FIG. 8 is a front view of the lighting module 700 shown in FIG. 7, with the control knob 708 of FIG. 7 removed. FIG. 9 is a side view of the lighting module 700 shown in FIGS. 7 and 8, with the control knob 708 of FIG. 7 removed.

As shown in FIGS. 8 and 9, the ring 706 of the LEDs 702 is also concentrically positioned relative to an example rotary encoder 802 having an example rotatable portion 804 (e.g., a rotatable shaft) to which the control knob 708 shown in FIG. 7 is mechanically coupled. The rotatable portion 804 of the rotary encoder 802 can be rotated relative to an example fixed portion 806 of the rotary encoder 802 via user interaction with the control knob 708 (e.g., manual rotation of the control knob 708). The fixed portion 806 of the rotary encoder 802 includes one or more sensor(s) that is/are configured to sense, measure, and/or detect the relative angular position of the rotatable portion 804 and/or the relative angular position of the control knob 708. The rotary encoder 802 of FIGS. 8 and 9 can be implemented by or as the first encoder 120 or the second encoder 124 of FIG. 1 described above. Data, information, and/or signals that is/are sensed, measured, and/or detected by the sensor(s) of the rotary encoder 802 can accordingly be transmitted directly to the controller 144 of FIG. 1, and/or can be transmitted to and stored in the memory 152 of FIG. 1. As shown in FIGS. 8 and 9, the fixed portion 806 of the rotary encoder 802 is mounted to, positioned on, and/or otherwise located relative to the printed circuit board 704 of the control panel. In the illustrated example of FIGS. 7-9, the ring 706 of the LEDs 702 circumscribes the rotary encoder 802 and also circumscribes the control knob 708. In other examples (e.g., when one or more portion(s) of the control knob 708 is/are transparent or translucent), the ring 706 of the LEDs 702 may circumscribe the rotary encoder 802, and the control knob 708 may circumscribe the ring 706 of the LEDs 702.

In the illustrated example of FIGS. 7-9, the lighting module 700 is spatially aligned (e.g., in front-to-rear and/or top-to-bottom alignment along a vertical plane) with the control knob 708 and/or the rotary encoder 802. In some examples (e.g., as discussed above in connection with FIGS. 1-6), the lighting module 700, the control knob 708, and/or the rotary encoder 802 is/are spatially aligned (e.g., in front-to-rear and/or top-to-bottom alignment along a vertical plane) with a corresponding one of the burner valve(s) (e.g., the first burner valve 112 or the second burner valve 114), and/or a corresponding one of the burner(s) (e.g., the first burner 102 or the second burner 104) of the grill 100. In such examples, the lighting module 700 will also be spatially aligned (e.g., in front-to-rear and/or top-to-bottom alignment along a vertical plane) with a portion and/or area of a corresponding one of the cooking grate(s) (e.g., a portion and/or area of the cooking grate 304) that is located directly above and/or directly over the corresponding one of the burner(s) (e.g., the first burner 102 or the second burner 104).

In other examples, the lighting module 700 can be spatially aligned (e.g., in front-to-rear and/or top-to-bottom alignment along a vertical plane) the control knob 708 and/or the rotary encoder 802 without being spatially aligned (e.g., in front-to-rear and/or top-to-bottom alignment along a vertical plane) with a corresponding one of the burner valve(s) (e.g., the first burner valve 112 or the second burner valve 114), and/or a corresponding one of the burner(s) (e.g., the first burner 102 or the second burner 104) of the grill 100. In still other examples, the lighting module 700 may not be spatially aligned (e.g., in front-to-rear and/or top-to-bottom alignment along a vertical plane) with any of the control knob 708, the rotary encoder 802, a corresponding one of the burner valve(s) (e.g., the first burner valve 112 or the second burner valve 114), and a corresponding one of the burner(s) (e.g., the first burner 102 or the second burner 104) of the grill 100. In such examples, the lighting module 700 may nonetheless be spatially aligned (e.g., in front-to-rear and/or top-to-bottom alignment along a vertical plane) with a portion and/or area of a corresponding one of the cooking grate(s) (e.g., a portion and/or area of the cooking grate 304) that is not located directly above and/or directly over any of the burner(s) (e.g., the first burner 102 or the second burner 104) of the grill 100.

In the illustrated example of FIGS. 7-9, the LEDs 702 of the lighting module 700 can be either individually or collectively controllable to transition from an off state (e.g., a non-light-projecting state) to an on state (e.g., a light-projecting state) and vice-versa, in response to instructions, commands, and/or signals (e.g., a supply of current) generated by the controller 144 of the grill 100. In this regard, the LEDs 702 can be individually or collectively instructed, commanded, and/or signaled (e.g., by the controller 144) to illuminate in a manner that causes one or more of the LEDs 702 to appear as being constantly lit (e.g., in a constant light-projecting state) over a duration of time. The LEDs 702 can alternatively be individually or collectively instructed, commanded, and/or signaled (e.g., by the controller 144) to illuminate in a manner that causes one or more of the LEDs 702 to appear as being periodically lit and/or blinking (e.g., switching up and back between a light-projecting state and a non-light-projecting state) over a duration of time. The LEDs 702 can alternatively be individually or collectively instructed, commanded, and/or signaled (e.g., by the controller 144) to cease illuminating such that one or more of the LEDs 702 appear(s) as being constantly unlit (e.g., in a constant non-light-projecting state) over a duration of time. The aforementioned illumination schemes (e.g., constantly lighting, pulsing, etc.) are example techniques by which the disclosed methods and apparatus can advantageously provide a user of the grill 100 with an intuitive “at-the-cookbox” visual identification (e.g., presented via one or more instance(s) of the lighting module 700) of one or more area(s) and/or location(s) within the cooking chamber 302 of the grill 100 at which one or more associated food movement step(s) of a cook program being executed by the controller 144 of the grill 100 is/are to be performed.

In some examples, the LEDs 702 of the lighting module 700 of FIGS. 7-9 are implemented as multi-color LEDs that can be individually or collectively instructed, commanded, and/or signaled (e.g., by the controller 144) to illuminate in different colors (e.g., white, red, blue, etc.) of the color spectrum. In some such examples, one or more of the multi-color LEDs 702 can be individually or collectively instructed, commanded, and/or signaled to illuminate in a first color (e.g., white) to indicate that the grill 100 is powered on, and a second color (e.g., red) to indicate an area and/or a location within the cooking chamber 302 of the grill 100 at which an associated food movement step of a cook program being executed by the controller 144 of the grill 100 is to be performed. The aforementioned color schemes are other example techniques by which the disclosed methods and apparatus can advantageously provide a user of the grill 100 with an intuitive “at-the-cookbox” visual identification (e.g., presented via one or more instance(s) of the lighting module 700) of one or more area(s) and/or location(s) within the cooking chamber 302 of the grill 100 at which one or more associated food movement step(s) of a cook program being executed by the controller 144 of the grill 100 is/are to be performed.

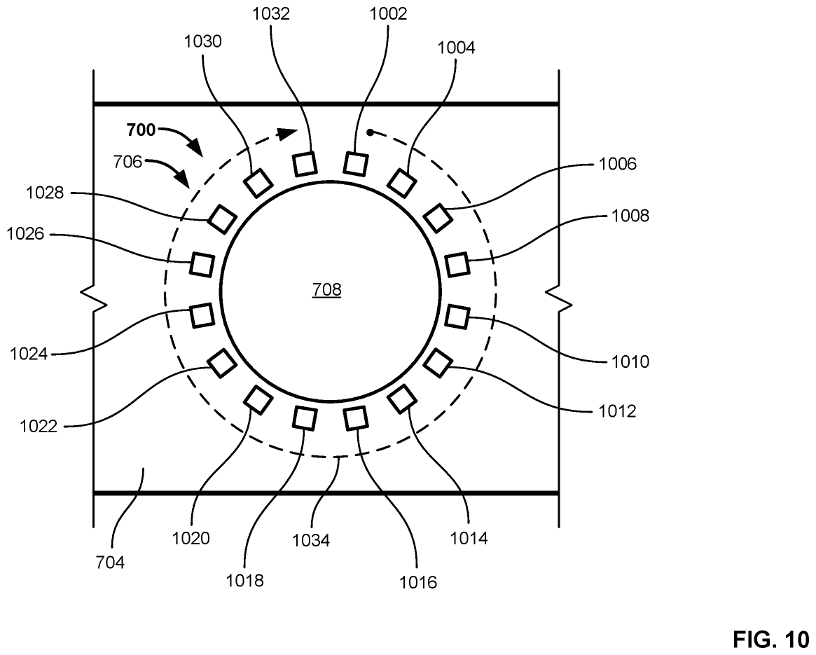

FIG. 10 is another front view of the lighting module 700 shown in FIGS. 7-9, with the control knob 708 of FIG. 7 included. In the illustrated example of FIG. 10, individual reference numerals have been applied to respective ones of the LEDs 702 shown and described in connection with FIGS. 7-9. In this regard, respective ones of the sixteen individual LEDs 702 shown in FIGS. 7-9 have been renumbered in FIG. 10 as a first LED 1002, a second LED 1004, a third LED 1006, a fourth LED 1008, a fifth LED 1010, a sixth LED 1012, a seventh LED 1014, an eighth LED 1016, a ninth LED 1018, a tenth LED 1020, an eleventh LED 1022, a twelfth LED 1024, a thirteenth LED 1026, a fourteenth LED 1028, a fifteenth LED 1030, and a sixteenth LED 1032, with the aforementioned LEDs being circumferentially arranged (e.g., around the control knob 708). In some examples, the respective ones of the aforementioned LEDs of the lighting module 700 of FIG. 10 can be instructed, commanded, and/or signaled (e.g., by the controller 144) to illuminate according to an example illumination pattern 1034. The illumination pattern 1034 is configured to indicate a time (e.g., a remaining time) at which and/or until a food movement step (e.g., adding an item of food to, removing an item of food from, and/or moving an item of food within the cooking chamber 302 of the grill 100) of a cook program being executed by the controller 144 of the grill is to be performed.

For example, implementation of the illumination pattern 1034 of FIG. 10 may cause the first LED 1002 to become illuminated when there is a time of three minutes and forty-five seconds remaining until the food movement step is to be performed. The illumination pattern 1034 may proceed in a circumferential manner, with respective ones of the LEDs becoming sequentially illuminated at 15 second intervals. For example, the second LED 1004 may become illuminated (e.g., while the first LED 1002 remains illuminated) when there is three minutes and thirty seconds remaining until the food movement step is to be performed. The third LED 1006 may become illuminated (e.g., while the first LED 1002 and the second LED 1004 remain illuminated) when there is three minutes and fifteen seconds remaining until the food movement step is to be performed. The illumination pattern 1034 may continue as such, with the sixteenth LED 1032 becoming illuminated (e.g., such that all sixteen of the LEDs of the ring 706 of the lighting module 700 are illuminated) when there is no (e.g., zero) time remaining until the food movement step is to be performed (i.e., when the time to perform the food movement step has arrived).

In other examples, the illumination pattern 1034 of FIG. 10 may be reversed in terms of the sequential circumferential direction with which respective ones of the LEDs become illuminated. For example, while the illustrated example of FIG. 10 describes the illumination pattern 1034 as progressing in a clockwise direction, other implementations of the illumination pattern 1034 could instead progress in a counterclockwise direction. In still other examples, the illumination pattern 1034 of FIG. 10 may be reversed in terms of the applied scheme. For example, while the illustrated example of FIG. 10 describes the illumination pattern 1034 as progressing from a fully unlit state of the ring 706 to a fully lit state of the ring 706 as the time at which the food movement step is to be performed approaches zero, other implementations of the illumination pattern 1034 could instead progress from a fully lit state of the ring 706 to a fully unlit state of the ring 706 as the time at which the food movement step is to be performed approaches zero. The illumination pattern 1034 of FIG. 10 and the above-described alternatives thereto can advantageously provide a user of the grill 100 with an intuitive “at-the-cookbox” visual identification (e.g., presented via the lighting module 700) of one or more time(s) at which one or more associated food movement step(s) of a cook program being executed by the controller 144 of the grill 100 is/are to be performed.

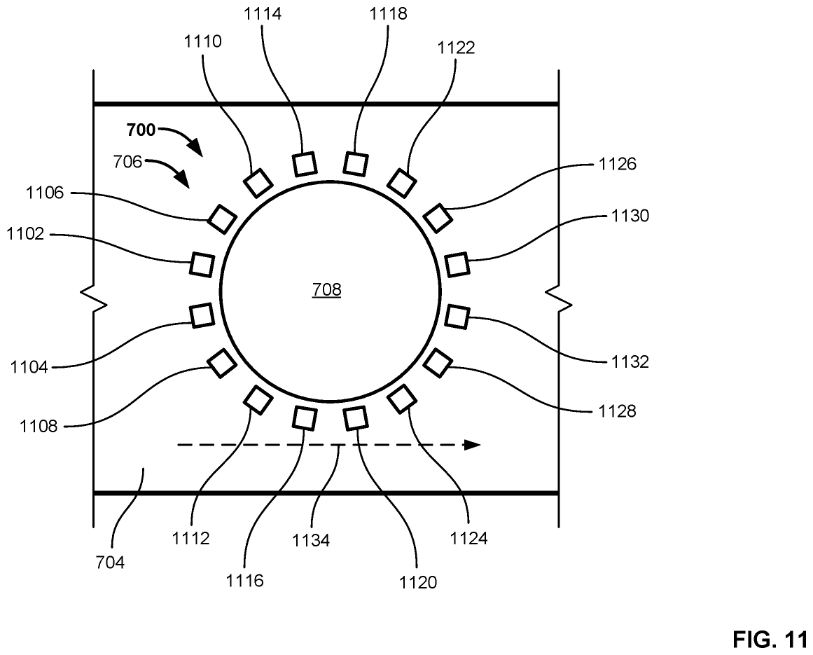

FIG. 11 is another front view of the lighting module 700 shown in FIGS. 7-9, with the control knob 708 of FIG. 7 included. In the illustrated example of FIG. 11, individual reference numerals have been applied to respective ones of the LEDs 702 shown and described in connection with FIGS. 7-9. In this regard, respective ones of the sixteen individual LEDs 702 shown in FIGS. 7-9 have been renumbered in FIG. 11 as a first LED 1102, a second LED 1104, a third LED 1106, a fourth LED 1108, a fifth LED 1110, a sixth LED 1112, a seventh LED 1114, an eighth LED 1116, a ninth LED 1118, a tenth LED 1120, an eleventh LED 1122, a twelfth LED 1124, a thirteenth LED 1126, a fourteenth LED 1128, a fifteenth LED 1130, and a sixteenth LED 1132. In some examples, the respective ones of the aforementioned LEDs of the lighting module 700 of FIG. 11 can be instructed, commanded, and/or signaled (e.g., by the controller 144) to illuminate according to an example illumination pattern 1134. The illumination pattern 1134 is configured to indicate a direction (e.g., a left-to-right direction within the cooking chamber 302 of the grill 100) in which a food movement step (e.g., moving an item of food within the cooking chamber 302 of the grill 100) of a cook program being executed by the controller 144 of the grill is to be performed.

For example, implementation of the illumination pattern 1134 of FIG. 11 may cause the first LED 1102 and the second LED 1104 to become illuminated at a first time consistent with initiating the visual presentation of a directional flow pattern. The illumination pattern 1134 may proceed in a sequential directional manner, with the third LED 1106 and the fourth LED 1108 becoming illuminated at a second time subsequent to the first time, and with the illumination of the first LED 1102 and the second LED 1104 being ceased (e.g., just prior to, concurrently with, or subsequent to the second time). Next, the fifth LED 1110 and the sixth LED 1112 may become illuminated at a third time subsequent to the second time, and the illumination of the third LED 1106 and the fourth LED 1108 may be ceased (e.g., just prior to, concurrently with, or subsequent to the third time). This directional sequence may continue until the fifteenth LED 1130 and the sixteenth LED 1132 become illuminated, and the illumination of the thirteenth LED 1126 and the fourteenth LED 1128 ceases (e.g., just prior to, concurrently with, or subsequent to the illumination of the fifteenth LED 1130 and the sixteenth LED 1132). The aforementioned progression of illuminating respective ones of the LEDs of the lighting module 700 provides a visual presentation of a directional flow pattern that indicates movement progressing from the left to the right.

In other examples, the illumination pattern 1134 of FIG. 11 may be reversed in terms of the direction with which respective ones of the LEDs become illuminated. For example, while the illustrated example of FIG. 11 describes the illumination pattern 1134 as progressing in direction moving from the left to the right, other implementations of the illumination pattern 1134 could instead progress in a direction moving from the right to the left. The illumination pattern 1134 of FIG. 11 and the above-described alternative thereto can advantageously provide a user of the grill 100 with an intuitive “at-the-cookbox” visual identification (e.g., presented via the lighting module 700) of one or more direction(s) in which one or more associated food movement step(s) of a cook program being executed by the controller 144 of the grill 100 is/are to be performed.

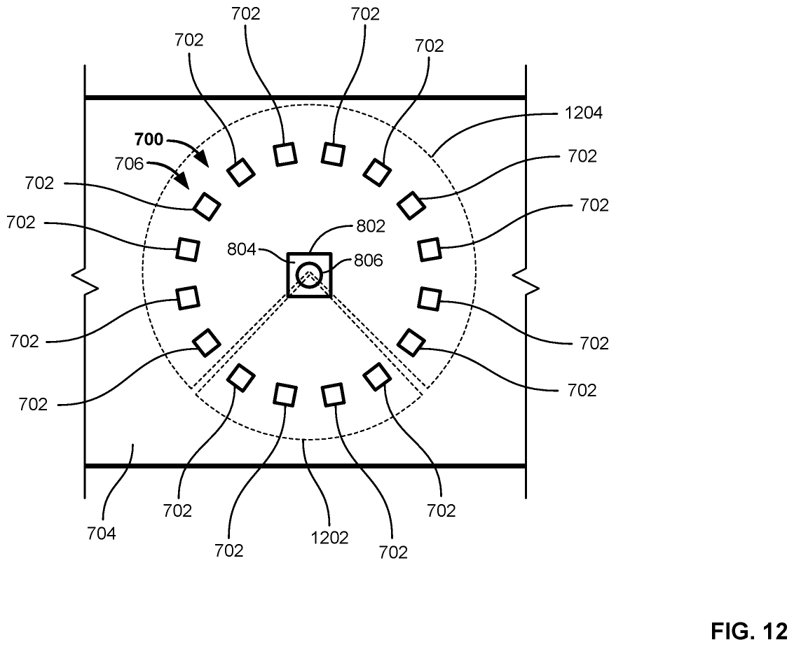

FIG. 12 is another front view of the lighting module 700 shown in FIGS. 7-9, with the control knob 708 of FIG. 7 removed for clarity. As shown in FIG. 12, the ring 706 of the LEDs 702 is partitioned into an example first sector 1202 that forms a first portion of the circumference of the ring 706, and an example second sector 1204 that forms a second portion of the circumference of the ring 706. In the illustrated example of FIG. 12, the first sector 1202 and the second sector 1204 are arranged in a non-overlapping manner, with the second sector 1204 being circumferentially complementary to the first sector 1202. In the illustrated example of FIG. 12, the first sector 1202 includes a lower four of the illustrated total of sixteen ones of the LEDs 702, and the second sector 1204 includes the remaining twelve of the illustrated sixteen ones of the LEDs 702. In other examples, the first sector 1202 and/or the second sector 1204 may respectively include a different number of the LEDs 702 relative to the example described above and shown in FIG. 12.

In the illustrated example of FIG. 12, the LEDs 702 included in the first sector 1202 are reserved for being illuminated one or more color(s) to provide a user of the grill 100 with a visual indication of an operational status of the grill 100 (e.g., that the grill 100 is powered on, that the grill 100 is in manual mode, that the grill 100 is in a controlled cooking mode associated with executing a cook program, etc.). In contrast to the LEDs 702 that are included in the first sector 1202, the LEDs 702 that are located in the second sector 1204 are reserved for being illuminated one or more color(s) to provide a user of the grill 100 with an intuitive “at-the-cookbox” visual identification of one or more area(s) and/or location(s) within the cooking chamber 302 of the grill 100 at which one or more associated food movement step(s) of a cook program being executed by the controller 144 of the grill 100 is/are to be performed. In other examples, the LEDs 702 that are located in the second sector 1204 can additionally or alternatively be reserved for being illuminated one or more color(s) according to a time-based illumination pattern (e.g., similar to the illumination pattern 1034 of FIG. 10 described above) to provide a user of the grill 100 with an intuitive “at-the-cookbox” visual identification of one or more time(s) at and/or until which one or more associated food movement step(s) of a cook program being executed by the controller 144 of the grill 100 is/are to be performed. In still other examples, the LEDs 702 that are located in the second sector 1204 can additionally or alternatively be reserved for being illuminated one or more color(s) according to a direction-based illumination pattern (e.g., similar to the illumination pattern 1134 of FIG. 11 described above) to provide a user of the grill 100 with an intuitive “at-the-cookbox” visual identification of one or more direction(s) in which one or more associated food movement step(s) of a cook program being executed by the controller 144 of the grill 100 is/are to be performed.

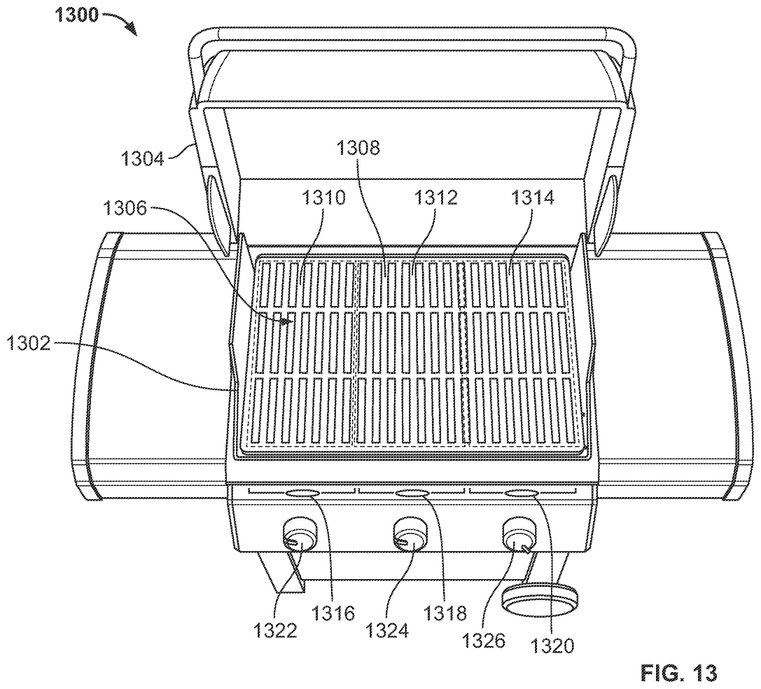

FIG. 13 is a perspective view of another example grill 1300 configured to present location-based food movement notifications. The grill 1300 of FIG. 13 includes an example cookbox 1302 and an example lid 1304, with the lid 1304 being movable relative to the cookbox 1302 between a closed position and an open position. The grill 1300 of FIG. 13 further includes an example cooking chamber 1306 defined by the cookbox 1302 and the lid 1304, with the cooking chamber 1306 being accessible to a user of the grill 1300 when the lid 1304 is in the open position, as generally shown in FIG. 13. In the illustrated example of FIG. 13, the cooking chamber 1306 and/or, more generally, the grill 1300 includes an example cooking grate 1308 having an example first area 1310 (e.g., a left area and/or zone), an example second area 1312 (e.g., a central area and/or zone), and an example third area 1314 (e.g., a right area and/or zone).

The grill 1300 of FIG. 13 further includes an example first lighting module 1316, an example second lighting module 1318, and an example third lighting module 1320 respectively located along a front portion of the cookbox 1302 and/or, more generally, along a front portion of the grill 1300. In the illustrated example of FIG. 13, the first lighting module 1316 is spatially aligned (e.g., in front-to-rear and/or top-to-bottom alignment along a first vertical plane) with the first area 1310 of the cooking grate 1308, the second lighting module 1318 is spatially aligned (e.g., in front-to-rear and/or top-to-bottom alignment along a second vertical plane spaced apart from the first vertical plane) with the second area 1312 of the cooking grate 1308, and the third lighting module 1320 is spatially aligned (e.g., in front-to-rear and/or top-to-bottom alignment along a third vertical plane spaced apart from the first vertical plane as well as the second vertical plane) with the third area 1314 of the cooking grate 1308. The first lighting module 1316, the second lighting module 1318, and the third lighting module 1320 can respectively be implemented by and/or as separate instances of the lighting module(s) 132 of the grill 100, as described above, with the first lighting module 1316, the second lighting module 1318, and the third lighting module 1320 being respectively configured to present one or more location-based food movement notification(s) associated with one or more food movement step(s) of one or more cook program(s).

The grill 1300 of FIG. 13 further includes an example first control knob 1322, an example second control knob 1324, and an example third control knob 1326 respectively located along a front portion of the cookbox 1302 and/or, more generally, along a front portion of the grill 1300. In the illustrated example of FIG. 13, the first control knob 1322 is spatially aligned (e.g., in front-to-rear and/or top-to-bottom alignment along a first vertical plane) with the first area 1310 of the cooking grate 1308 and/or with the first lighting module 1316, the second control knob 1324 is spatially aligned (e.g., in front-to-rear and/or top-to-bottom alignment along a second vertical plane spaced apart from the first vertical plane) with the second area 1312 of the cooking grate 1308 and/or with the second lighting module 1318, and the third control knob 1326 is spatially aligned (e.g., in front-to-rear and/or top-to-bottom alignment along a third vertical plane spaced apart from the first vertical plane as well as the second vertical plane) with the third area 1314 of the cooking grate 1308 and/or with the third lighting module 1320.

In the illustrated example of FIG. 13, the first control knob 1322 is positioned directly below the first lighting module 1316, the second control knob 1324 is positioned directly below the second lighting module 1318, and the third control knob 1326 is positioned directly below the third lighting module 1320. In other examples, the first control knob 1322 can alternatively be positioned directly above the first lighting module 1316, the second control knob 1324 can alternatively instead be positioned directly above the second lighting module 1318, and the third control knob 1326 can alternatively be positioned directly above the third lighting module 1320. In still other examples, the first control knob 1322 can alternatively circumscribe (or be circumscribed by) the first lighting module 1316, the second control knob 1324 can alternatively circumscribe (or be circumscribed by) the second lighting module 1318, and the third control knob 1326 can alternatively circumscribe (or be circumscribed by) the third lighting module 1320.

In the illustrated example of FIG. 13, the first control knob 1322, the second control knob 1324, and the third control knob 1326 are respectively configured to control a flow of gas from a manifold of the grill 1300 through corresponding ones of a first burner valve, a second burner valve, and a third burner valve of the grill 1300 and into corresponding ones of a first burner, a second burner, and a third burner of the grill 1300. The first burner, the second burner, and the third burner of the grill 1300 can via corresponding first, second, and third linear burner tubes having a front-to-rear orientation within the cookbox 1302 of the grill 1300, and with respective ones of the first burner, the second burner, and the third burner being positioned directly below corresponding ones of the first area 1310, the second area 1312, and the third area 1314 of the cooking grate 1308. In some examples, the first control knob 1322, the second control knob 1324, and the third control knob 1326 can be configured to control corresponding ones of the first burner valve, the second burner valve, and the third burner valve of the grill 1300 via a “control-by-wire” architecture that eliminates any mechanical connection between the control knob and its corresponding burner valve. In other examples, the first control knob 1322, the second control knob 1324, and the third control knob 1326 can be configured to control corresponding ones of the first burner valve, the second burner valve, and the third burner valve of the grill 1300 via a conventional architecture that includes a mechanical connection between each control knob and its corresponding burner valve.

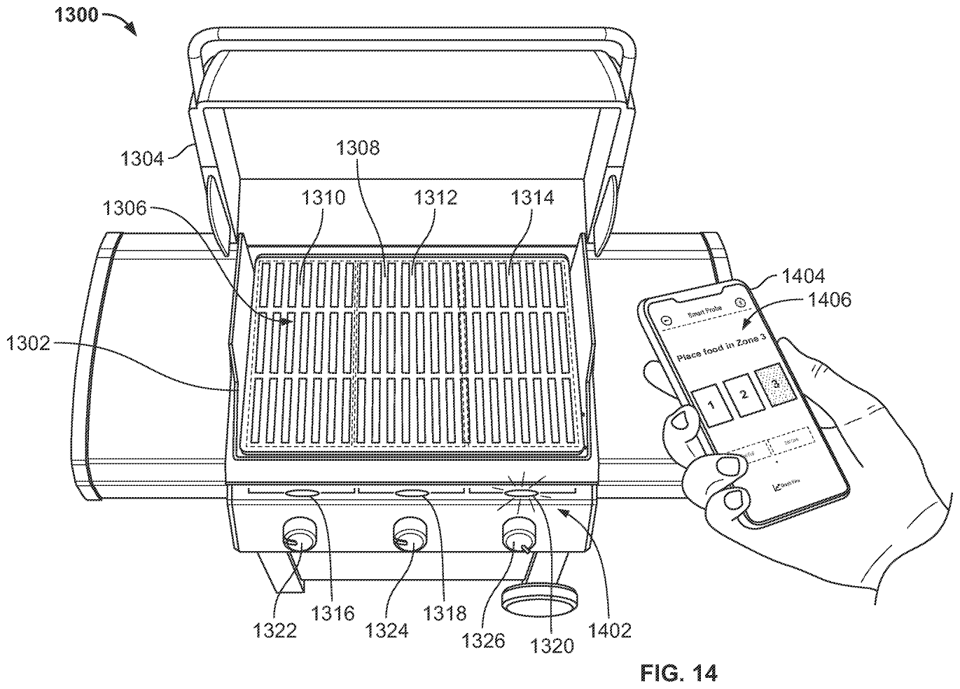

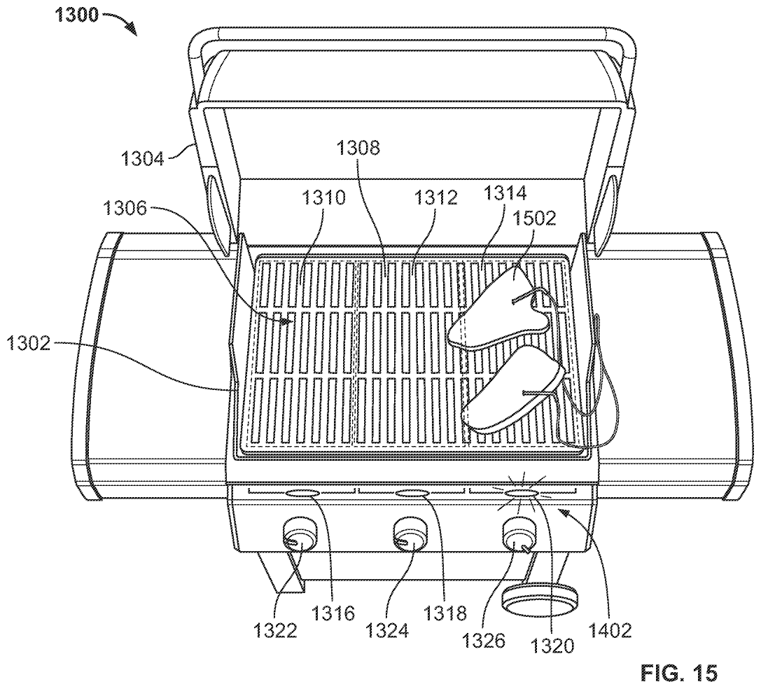

FIG. 14 is a perspective view of the grill 1300 of FIG. 13, with the third lighting module 1320 of FIG. 13 shown presenting an example location-based food movement notification 1402. In the illustrated example of FIG. 14, the third lighting module 1320 presents the location-based food movement notification 1402 locally at the grill 1300 such that the location-based food movement notification 1402 provides a user of the grill 1300 with an intuitive “at-the-cookbox” visual identification of the third area 1314 of the cooking grate 1308 of the grill 1300 at which an associated food movement step of a cook program is to occur. For example, when presented via the third lighting module 1320, the location-based food movement notification 1402 of FIG. 14 may provide the user of the grill 1300 with a visual indication (e.g., a viewable, light-based indication) that intuitively informs the user of the grill 1300 that one or more food item(s) (e.g., one or more steak(s)) is/are to be added to the cooking chamber 1306 of the grill 1300 at and/or on the third area 1314 of the cooking grate 1308. In response to the presentation of the location-based food movement notification 1402 via the third lighting module 1320, the user of the grill 1300 may add one or more example steak(s) 1502 to the cooking chamber 1306 of the grill 1300 at and/or on the third area 1314 of the cooking grate 1308 of the grill 1300, as generally shown in FIG. 15.

In some examples, another food movement notification, which may or may not be a location-based food movement notification, can additionally be presented to the user of the grill 1300 via a remotely-located device. For example, as shown in FIG. 14 the user may possess an example mobile device 1404 (e.g., a smartphone) that has been configured to execute an application associated with one or more cook program(s) to be implemented at the grill 1300. Execution of the application may cause the mobile device 1404 to display and/or otherwise present one or more food movement notification(s) that alert and/or otherwise inform the user of the grill 1300 a cook program has advanced to a food movement step which requires the user's presence at the grill 1300. For example, as shown in FIG. 14, the mobile device 1404 is displaying an example location-based food movement notification 1406 that mimics and/or otherwise resembles the location-based food movement notification 1402 being presented via the third lighting module 1320 of the grill 1300. In such an example, the location-based food movement notification 1406 presented via the mobile device 1404 supplements the location-based food movement notification 1402 presented via the third lighting module 1320 of the grill 1300. In other examples, the location-based food movement notification 1402 presented via the third lighting module 1320 of the grill 1300 may be presented without being supplemented by the presentation of any food movement notification via the mobile device 1404.

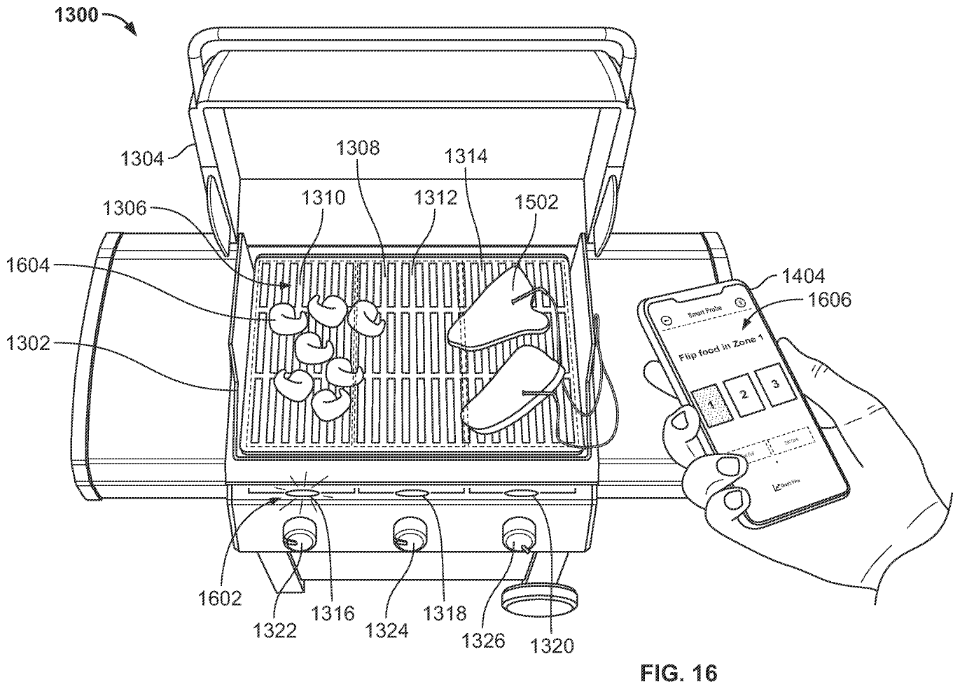

FIG. 16 is a perspective view of the grill 1300 of FIGS. 13-15, with the first lighting module 1316 of FIGS. 13-15 shown presenting an example location-based food movement notification 1602. As further shown in FIG. 16, one or more example shrimp 1604 is/are located at and/or on the first area 1310 of the cooking grate 1308, and one or more steak(s) 1502 is/are located at and/or on the third area 1314 of the cooking grate 1308. In the illustrated example of FIG. 16, the first lighting module 1316 presents the location-based food movement notification 1602 locally at the grill 1300 such that the location-based food movement notification 1602 provides a user of the grill 1300 with an intuitive “at-the-cookbox” visual identification of the first area 1310 of the cooking grate 1308 of the grill 1300 at which an associated food movement step of a cook program is to occur. For example, when presented via the first lighting module 1316, the location-based food movement notification 1602 of FIG. 16 may provide the user of the grill 1300 with a visual indication (e.g., a viewable, light-based indication) that intuitively informs the user of the grill 1300 that one or more shrimp 1604 located within the cooking chamber 1306 at and/or on the first area 1310 of the cooking grate 1308 are to be flipped.

As further shown in FIG. 16, the mobile device 1404 is displaying an example location-based food movement notification 1606 that mimics and/or otherwise resembles the location-based food movement notification 1602 being presented via the first lighting module 1316 of the grill 1300. In such an example, the location-based food movement notification 1606 presented via the mobile device 1404 supplements the location-based food movement notification 1602 presented via the first lighting module 1316 of the grill 1300. In other examples, the location-based food movement notification 1602 presented via the first lighting module 1316 of the grill 1300 may be presented without being supplemented by the presentation of any food movement notification via the mobile device 1404.

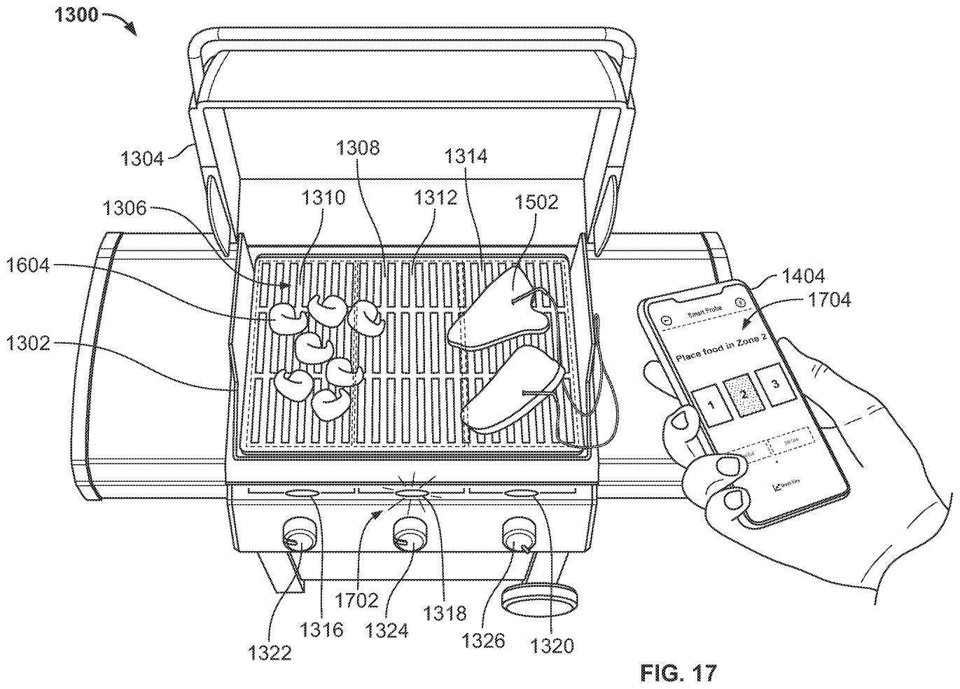

FIG. 17 is a perspective view of the grill 1300 of FIGS. 13-16, with the second lighting module 1318 of FIGS. 13-16 shown presenting an example location-based food movement notification 1702. As further shown in FIG. 17, one or more shrimp 1604 is/are located at and/or on the first area 1310 of the cooking grate 1308, and one or more steak(s) 1502 is/are located at and/or on the third area 1314 of the cooking grate 1308. In the illustrated example of FIG. 17, the second lighting module 1318 presents the location-based food movement notification 1702 locally at the grill 1300 such that the location-based food movement notification 1702 provides a user of the grill 1300 with an intuitive “at-the-cookbox” visual identification of the second area 1312 of the cooking grate 1308 of the grill 1300 at which an associated food movement step of a cook program is to occur. For example, when presented via the second lighting module 1318, the location-based food movement notification 1702 of FIG. 17 may provide the user of the grill 1300 with a visual indication (e.g., a viewable, light-based indication) that intuitively informs the user of the grill 1300 that one or more food item(s) (e.g., one or more hamburger(s)) is/are to be added to the cooking chamber 1306 of the grill 1300 at and/or on the second area 1312 of the cooking grate 1308.

As further shown in FIG. 17, the mobile device 1404 is displaying an example location-based food movement notification 1704 that mimics and/or otherwise resembles the location-based food movement notification 1702 being presented via the second lighting module 1318 of the grill 1300. In such an example, the location-based food movement notification 1704 presented via the mobile device 1404 supplements the location-based food movement notification 1702 presented via the second lighting module 1318 of the grill 1300. In other examples, the location-based food movement notification 1702 presented via the second lighting module 1318 of the grill 1300 may be presented without being supplemented by the presentation of any food movement notification via the mobile device 1404.

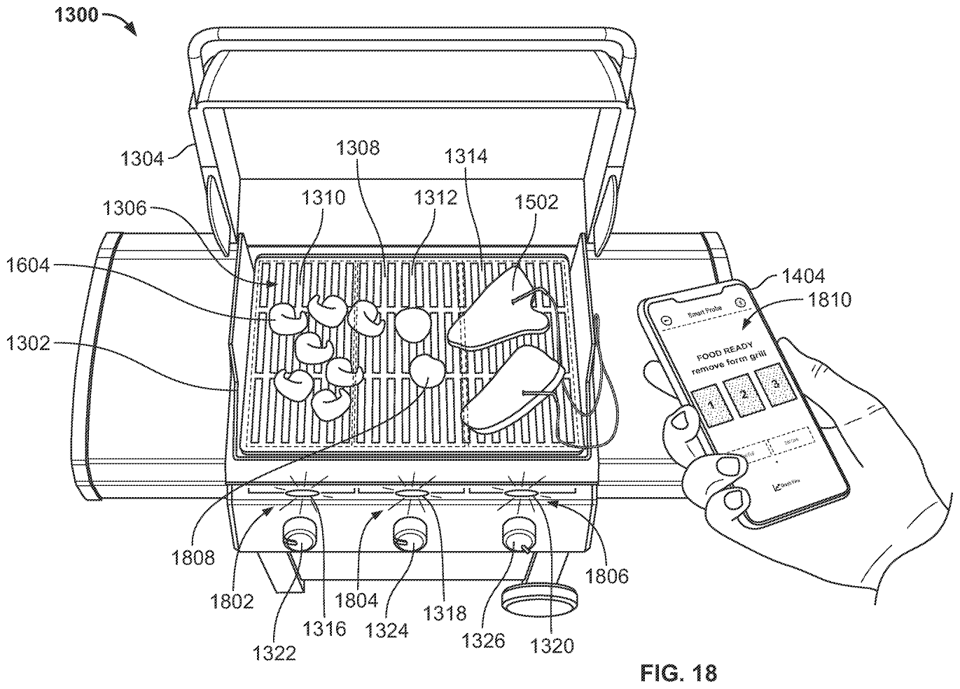

FIG. 18 is a perspective view of the grill 1300 of FIGS. 13-17, with the first lighting module 1316, the second lighting module 1318, and the third lighting module 1320 of FIGS. 13-17 shown presenting corresponding location-based food movement notifications including a first example location-based food movement notification 1802 presented via the first lighting module 1316, a second example location-based food movement notification 1804 presented via the second lighting module 1318, and a third example location-based food movement notification 1806 presented via the third lighting module 1320. As further shown in FIG. 18, one or more shrimp 1604 is/are located at and/or on the first area 1310 of the cooking grate 1308, one or more example hamburger(s) 1808 is/are located at and/or on the second are 1312 of the cooking grate 1308, and one or more steak(s) 1502 is/are located at and/or on the third area 1314 of the cooking grate 1308. In the illustrated example of FIG. 18, the first, second, and third lighting modules 1316, 1318, 1320 respectively present corresponding ones of the first, second, and third location-based food movement notifications 1802, 1804, 1806 locally at the grill 1300 such that the first, second, and third location-based food movement notifications 1802, 1804, 1806 respectively provide a user of the grill 1300 with an intuitive “at-the-cookbox” visual identification of the first, second, and third areas 1310, 1312, 1314 of the cooking grate 1308 of the grill 1300 at which an associated food movement step of a cook program is to occur. For example, when respectively presented via the first, second, and third lighting modules 1316, 1318, 1320, the first, second, and third location-based food movement notifications 1802, 1804, 1806 of FIG. 18 may respectively provide the user of the grill 1300 with a visual indication (e.g., a viewable, light-based indication) that intuitively informs the user of the grill 1300 that the shrimp 1604 located at and/or on the first area 1310 of the cooking grate 1308, the hamburger(s) 1808 located at and/or on the second area 1312 of the cooking grate 1308, and the steak(s) 1502 located at and/or on the third area 1314 of the cooking grate 1308 are to be removed from the cooking chamber 1306 of the grill 1300.

As further shown in FIG. 18, the mobile device 1404 is displaying an example location-based food movement notification 1810 that mimics and/or otherwise resembles the first, second, and third location-based food movement notifications 1802, 1804, 1806 being presented via the first, second, and third lighting modules 1316, 1318, 1320 of the grill 1300. In such an example, the location-based food movement notification 1810 presented via the mobile device 1404 supplements the first, second, and third location-based food movement notifications 1802, 1804, 1806 presented via the first, second, and third lighting modules 1316, 1318, 1320 of the grill 1300. In other examples, the first, second, and third location-based food movement notifications 1802, 1804, 1806 presented via corresponding ones of the first, second, and third lighting modules 1316, 1318, 1320 of the grill 1300 may be presented without being supplemented by the presentation of any food movement notification via the mobile device 1404.

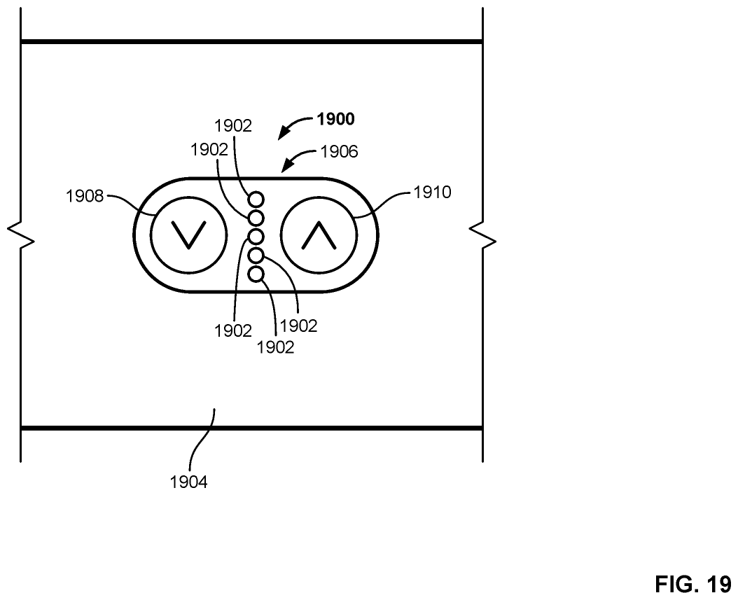

FIG. 19 a front view of another example lighting module 1900 that may be implemented as one of the lighting module(s) 132 of FIG. 1. In the illustrated example of FIG. 19, the lighting module 1900 includes a plurality of example LEDs 1902 mounted to, positioned on, and/or otherwise located relative to an example control panel 1904. As shown in FIG. 19, the LEDs 1902 are configured as an example linear series 1906 (e.g., a vertically-oriented column, a horizontally-oriented row, etc.), with the linear series 1906 being positioned between a first example control button 1908 and a second example control button 1910 that are also mounted to, positioned on, and/or otherwise located relative to the control panel 1904. In some examples, the first control button 1908 and the second control button 1910 are actuatable (e.g., by a user of the grill 100) to control a flow of gas to a burner (e.g., the first burner 102 or the second burner 104) of the grill 100.

In some examples, the lighting module 1900 of FIG. 19 is spatially aligned (e.g., in front-to-rear and/or top-to-bottom alignment along a vertical plane) with a corresponding one of the burner valve(s) (e.g., the first burner valve 112 or the second burner valve 114), and/or a corresponding one of the burner(s) (e.g., the first burner 102 or the second burner 104) of the grill 100. In such examples, the lighting module 1900 will also be spatially aligned (e.g., in front-to-rear and/or top-to-bottom alignment along a vertical plane) with a portion and/or area of a corresponding one of the cooking grate(s) (e.g., a portion and/or area of the cooking grate 304) that is located directly above and/or directly over the corresponding one of the burner(s) (e.g., the first burner 102 or the second burner 104).

In the illustrated example of FIG. 19, the LEDs 1902 of the lighting module 1900 can be either individually or collectively controllable to transition from an off state (e.g., a non-light-projecting state) to an on state (e.g., a light-projecting state) and vice-versa, in response to instructions, commands, and/or signals (e.g., a supply of current) generated by the controller 144 of the grill 100. In this regard, the LEDs 1902 can be individually or collectively commanded (e.g., by the controller 144) to illuminate in a manner that causes one or more of the LEDs 1902 to appear as being constantly lit (e.g., in a constant light-projecting state) over a duration of time. The LEDs 1902 can alternatively be individually or collectively commanded (e.g., by the controller 144) to illuminate in a manner that causes one or more of the LEDs 1902 to appear as being periodically lit and/or blinking (e.g., switching up and back between a light-projecting state and a non-light-projecting state) over a duration of time. The LEDs 1902 can alternatively be individually or collectively commanded (e.g., by the controller 144) to cease illuminating such that one or more of the LEDs 1902 appear(s) as being constantly unlit (e.g., in a constant non-light-projecting state) over a duration of time. The aforementioned illumination schemes (e.g., constantly lighting, pulsing, etc.) are example techniques by which the disclosed methods and apparatus can advantageously provide a user of the grill 100 with an intuitive “at-the-cookbox” visual identification (e.g., presented via one or more instance(s) of the lighting module 1900) of one or more area(s) and/or location(s) within the cooking chamber 302 of the grill 100 at which one or more associated food movement step(s) of a cook program being executed by the controller 144 of the grill 100 is/are to be performed.

In some examples, the LEDs 1902 of the lighting module 1900 of FIG. 19 are implemented as multi-color LEDs that can be individually or collectively instructed, commanded, and/or signaled (e.g., by the controller 144) to illuminate in different colors (e.g., white, red, blue, etc.) of the color spectrum. In some such examples, one or more of the multi-color LEDs 1902 can be individually or collectively instructed, commanded, and/or signaled to illuminate in a first color (e.g., white) to indicate that the grill 100 is powered on, and a second color (e.g., red) to indicate an area and/or a location within the cooking chamber 302 of the grill 100 at which an associated food movement step of a cook program being executed by the controller 144 of the grill 100 is to be performed. The aforementioned color schemes are other example techniques by which the disclosed methods and apparatus can advantageously provide a user of the grill 100 with an intuitive “at-the-cookbox” visual identification (e.g., presented via one or more instance(s) of the lighting module 1900) of one or more area(s) and/or location(s) within the cooking chamber 302 of the grill 100 at which one or more associated food movement step(s) of a cook program being executed by the controller 144 of the grill 100 is/are to be performed.

In some examples, respective ones of the LEDs 1902 of the lighting module 1900 of FIG. 19 can be instructed, commanded, and/or signaled (e.g., by the controller 144) to illuminate according to an illumination pattern. The illumination pattern is configured to indicate a time (e.g., a remaining time) at which and/or until a food movement step (e.g., adding an item of food to, removing an item of food from, and/or moving an item of food within the cooking chamber 302 of the grill 100) of a cook program being executed by the controller 144 of the grill is to be performed. For example, implementation of an example illumination pattern may cause a first one (e.g., the bottom one) of the LEDs 1902 to become illuminated when there is a time of one minute and thirty seconds remaining until the food movement step is to be performed. The illumination pattern may proceed in a sequential manner across the linear series 1906, with respective ones of the LEDs 1902 in the linear series 1906 becoming sequentially illuminated at 15 second intervals. In other examples, the illumination pattern may be reversed in terms of the applied scheme. For example, rather than the illumination pattern progressing from a fully unlit state of the linear series 1906 to a fully lit state of the linear series 1906 as the time at which the food movement step is to be performed approaches zero, other implementations of the illumination pattern could instead progress from a fully lit state of the linear series 1906 to a fully unlit state of the linear series 1906 as the time at which the food movement step is to be performed approaches zero. The above-described illumination patters can advantageously provide a user of the grill 100 with an intuitive “at-the-cookbox” visual identification (e.g., presented via the lighting module 1900) of one or more time(s) at which one or more associated food movement step(s) of a cook program being executed by the controller 144 of the grill 100 is/are to be performed.

Returning to the illustrated example of FIG. 1, the user interface 134 of FIG. 1 includes one or more input device(s) 136 (e.g., buttons, dials, knobs, switches, touchscreens, etc.) and/or one or more output device(s) 138 (e.g., liquid crystal displays, light emitting diodes, speakers, etc.) that enable a user of the grill 100 to interact with the above-described control system of the grill 100. The output device(s) 138 of the user interface 134 can be configured to present one or more notification(s) textually (e.g., as a written notification, message, or alert), graphically (e.g., as an illustrated or viewable notification, message, or alert), and/or audibly (e.g., as an audible notification, message, or alert).

In the illustrated example of FIG. 1, the user interface 134 is operatively coupled to (e.g., in electrical communication with) the controller 144 and/or the memory 152 of the grill 100. In some examples, the user interface 134 is mechanically coupled to (e.g., fixedly connected to) the grill 100. For example, the user interface 134 can be mounted to the cookbox 202, the lid 204, the handle 206, the frame 208, the cabinet 210, the control panel 212, the first side table 214, and/or the second side table 216 of the grill 100. The user interface 134 is preferably mounted to a portion of the grill 100 that is readily accessible to a user of the grill 100, such as a front portion of the cookbox 202, a front portion of the lid 204, a front portion of the handle 206, a front portion of the frame 208, a front portion of the cabinet 210, a front portion of the control panel 212, a front portion of the first side table 214, and/or a front portion of the second side table 216 of the grill 100.

In some examples, respective ones of the input device(s) 136 and/or the output device(s) 138 of the user interface 134 can be mounted to different portions of the grill 100. For example, a first one of the input device(s) 136 can be mounted to a side portion of either the cookbox 202, the lid 204, the handle 206, the frame 208, the cabinet 210, the control panel 212, the first side table 214, or the second side table 216 of the grill 100, and a second one of the input device(s) 136 can be mounted to a front portion of either the cookbox 202, the lid 204, the handle 206, the frame 208, the cabinet 210, the control panel 212, the first side table 214, or the second side table 216 of the grill 100. The architecture and/or operations of the user interface 134 can be distributed among any number of user interfaces respectively having any number of input device(s) 136 and/or output device(s) 138 located at and/or mounted to any portion of the grill 100.

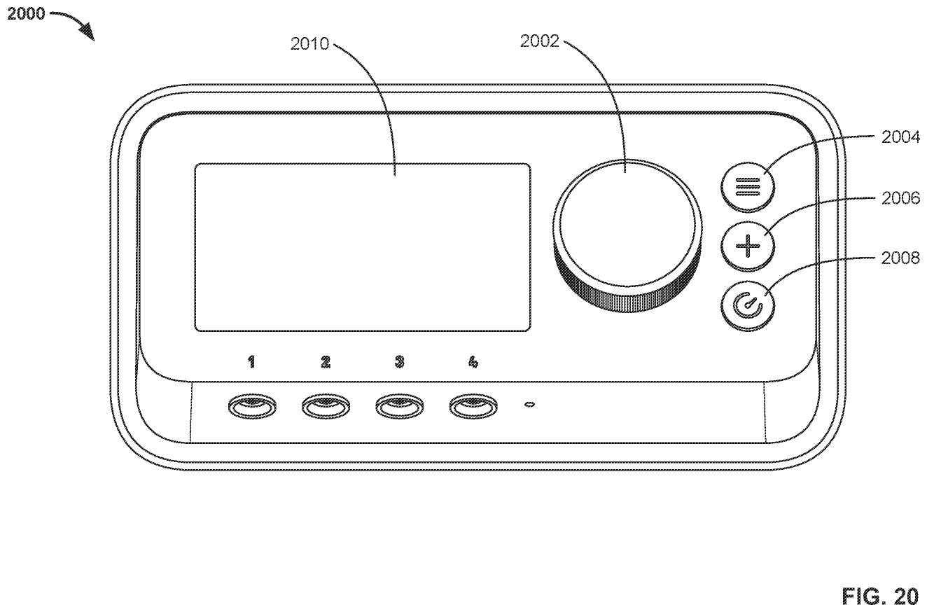

FIG. 20 a front view of an example user interface 2000 that can be implemented by or as the user interface 134 of the grill 100 of FIG. 1. As shown in FIG. 20, the user interface 2000 includes an example dial 2002, an example first button 2004, an example second button 2006, and an example third button 2008 that can be implemented by or as the input device(s) 136 of the user interface 134 of FIG. 1, and an example display 2010 that can be implemented by or as the output device(s) 138 of the user interface 134 of FIG. 1. In the illustrated example of FIG. 20, the dial 2002 of the user interface 2000 is a selection dial that can be rotated by a user of the grill 100 to adjust temperatures of the grill 100, and/or to navigate through options presented on the display 2010 of the user interface 2000. In addition to being rotatable, the dial 2002 can also be pushed by a user of the grill 100 to make and/or confirm a selection of one of the options presented on the display 2010. The first button 2004 of the user interface 2000 is a menu button that can be pressed by a user of the grill 100 to access a main menu (e.g., a “home” menu) of selectable options, and to cause the main menu to be presented on the display 2010 of the user interface 2000. The second button 2006 of the user interface 2000 is a cook program button that can be pressed by a user of the grill 100 to access a library of selectable cook programs, and to cause steps, instructions, operations, notifications, and/or alerts associated with the selectable cook programs to be presented on the display 2010 of the user interface 2000. The third button 2008 of the user interface 2000 is a timer button that can be pressed by a user of the grill 100 to initiate a timer, and to cause the running time associated with the timer to be presented on the display 2010 of the user interface 2000. The display 2010 of the user interface 2000 is a liquid crystal display configured to present textual and/or graphical information to a user of the grill 100. In some examples, the display 2010 can be implemented as a touch screen, in which case the display 2010 can be implemented not only as one of the output device(s) 138 of the user interface 134, but also as another one of the input device(s) 136 of the user interface 134.

The network interface 140 of FIG. 1 includes one or more communication device(s) 142 (e.g., transmitter(s), receiver(s), transceiver(s), modem(s), gateway(s), wireless access point(s), etc.) to facilitate exchange of data with external machines (e.g., computing devices of any kind, including the remote device(s) 154 of FIG. 1) by a wired or wireless communication network. Communications transmitted and/or received via the communication device(s) 142 and/or, more generally, via the network interface 140 can be made over and/or carried by, for example, an Ethernet connection, a digital subscriber line (DSL) connection, a telephone line connection, a coaxial cable system, a satellite system, a wireless system, a cellular telephone system, an optical connection, etc. The network interface 140 enables a user of the grill 100 to remotely interact (e.g., via one or more of the remote device(s) 154) with the above-described control system of the grill 100. In the illustrated example of FIG. 1, the network interface 140 is operatively coupled to (e.g., in electrical communication with) the controller 144 and/or the memory 152 of the grill 100.

The remote device(s) 154 of FIG. 1 can be implemented by any type(s) and/or any number(s) of mobile or stationary computing devices. In this regard, examples of such remote device(s) 154 include a smartphone, a tablet, a laptop, a desktop, a cloud server, a wearable computing device, etc. The remote device(s) 154 of FIG. 1 facilitate a remote (e.g., wired, or wireless) extension of the above-described user interface 134 of the grill 100. In this regard, each remote device 154 includes one or more input device(s) and/or one or more output device(s) that mimic and/or enable a remotely-located version of the above-described functionality of the corresponding input device(s) 136 and/or the corresponding output device(s) 138 of the user interface 134 of the grill 100. Accordingly, one or more notification(s) transmitted from the grill 100 (e.g., via the communication device(s) 142 of the network interface 140 of the grill 100) can be presented via the output device(s) of the remote device(s) 154 much in the same way that such notification(s) would be presented via the output device(s) 138 of the user interface 134 of the grill 100.

The controller 144 of FIG. 1 manages and/or controls the control system of the grill 100 and/or the components thereof. In the illustrated example of FIG. 1, the controller 144 is operatively coupled to (e.g., in electrical communication with) the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), and/or the memory 152 of the grill 100 of FIG. 1. The controller 144 of FIG. 1 is also operatively coupled to (e.g., in wired or wireless electrical communication with) the remote device(s) 154 of FIG. 1 via the network interface 140 (e.g., including the communication device(s) 142) of the grill 100 of FIG. 1. In the illustrated example of FIG. 1, the controller 144 includes the control circuitry 146, the detection circuitry 148, and the cook program circuitry 150 of FIG. 1, each of which is discussed in further detail herein. The control circuitry 146, the detection circuitry 148, the cook program circuitry 150, and/or, more generally, the controller 144 of FIG. 1 can individually and/or collectively be implemented by any type(s) and/or any number(s) of semiconductor device(s) (e.g., processor(s), microprocessor(s), microcontroller(s), etc.) and/or circuit(s).

In the illustrated example of FIG. 1, the controller 144 is graphically represented as a single, discrete structure that manages and/or controls the operation(s) of various components of the control system of the grill 100. It is to be understood, however, that in other examples, the architecture and/or operations of the controller 144 can be distributed among any number of controllers, with each separate controller having a dedicated subset of one or more operation(s) described herein. As but one example, the controller 144 of FIG. 1 can be separated into three distinct controllers, whereby a first one of the three controllers includes the control circuitry 146 of the controller 144, a second one of the three controllers includes the detection circuitry 148 of the controller 144, and a third one of the three controllers includes the cook program circuitry 150 of the controller 144. In some examples, the grill 100 can further include separate, distinct controllers for one or more of the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), and/or the memory 152 of the grill 100 of FIG. 1.

The controller 144 of FIG. 1 manages and/or controls the selection and implementation of cook programs for the grill 100 of FIG. 1. In this regard, one or more cook program(s) to be implemented via the controller 144 and/or, more generally, via the control system of the grill 100 can be selected (e.g., by a user of the grill 100) from among a library of selectable cook programs that are available for implementation. In some examples, the controller 144 determines whether a cook program selection has been received at the grill 100. For example, the controller 144 may determine that a cook program selection has been received based on a user input, a user selection, and/or a user interaction (e.g., a press, a push, a pull, a rotation, a click, a flip, a swipe, a touch, etc.) to, of, and/or with one or more of the input device(s) 136 (e.g., a button, a dial, a knob, a switch, a touchscreen, etc.) of the user interface 134 of FIG. 1. As another example, the controller 144 may determine that a cook program selection has been received based on a user input, a user selection, and/or a user interaction (e.g., a press, a push, a pull, a rotation, a click, a flip, a swipe, a touch, etc.) to, of, and/or with one or more input device(s) (e.g., a button, a dial, a knob, a switch, a touchscreen, etc.) of one of the remote device(s) 154 of FIG. 1, as received and/or detected via the network interface 140 of FIG. 1. In response to determining that a cook program selection has been received at the grill 100, the controller 144 invokes the control circuitry 146, the detection circuitry 148, and/or the cook program circuitry 150 of FIG. 1 to implement (e.g., execute) the selected cook program via the control system of the grill 100, as further described herein.

In connection with managing and/or controlling the implementation of cook programs for the grill 100 of FIG. 1, the controller 144 of FIG. 1 manages and/or controls the implementation and/or execution of one or more process(es), protocol(s), program(s), sequence(s), and/or method(s) associated with causing one or more of the lighting module(s) 132 of the grill 100 of FIG. 1 to present location-based food movement notifications at the grill 100. When presented, the location-based food movement notifications are configured to intuitively inform a user of the grill 100 of one or more area(s) and/or location(s) within the cooking chamber 302 of the grill 100 at which one or more associated food movement step(s) of a cook program being executed by the controller 144 of the grill 100 is/are to be performed. The controller 144 may invoke the control circuitry 146, the detection circuitry 148, and/or the cook program circuitry 150 of FIG. 1 in connection with implementing (e.g., executing) the presentation of such location-based food movement notifications at the grill 100, as further described herein.

The control circuitry 146 of the controller 144 of FIG. 1 manages and/or controls one or more operation(s) of one or more controllable component(s) of the grill 100 that is/are operatively coupled to (e.g., in electrical communication with) the controller 144 of the grill 100. For example, the control circuitry 146 may include valve control circuitry configured to instruct, command, signal, and/or otherwise cause the fuel source valve 108, the first burner valve 112, and/or the second burner valve 114 of the grill 100 to open (e.g., fully open), to close (e.g., fully close), or to otherwise change position. The control circuitry 146 may additionally or alternatively include ignitor control circuitry configured to instruct, command, signal, and/or otherwise cause the first ignitor 116 and/or the second ignitor 118 of the grill 100 to ignite corresponding ones of the first burner 102 and/or the second burner 104 of the grill 100. The control circuitry 146 may additionally or alternatively include lighting control circuitry configured to instruct, command, signal, and/or otherwise cause one or more light source(s) of one or more of the lighting module(s) 132 of the grill 100 to transition (e.g., once, or repeatedly) from an off state (e.g., a non-light-projecting state) to an on state (e.g., a light-projecting state), or vice-versa. In some examples, the transitioning of the one or more light source(s) of one or more of the lighting module(s) 132 from the off state to the on state, or vice-versa, effects the presentation of one or more visual notification(s) (e.g., one or more viewable, light-based indication(s)).

The control circuitry 146 may additionally or alternatively include user interface control circuitry configured to instruct, command, signal, and/or otherwise cause one or more of the output device(s) 138 of the user interface 134 of the grill 100 to textually, graphically, or audibly present data and/or information, which may include one or more notification(s) (e.g., one or more visible, audible, and/or tactile message(s) or alert(s)). The control circuitry 146 may additionally or alternatively include network interface control circuitry configured to instruct, command, signal, and/or otherwise cause one or more of the communication device(s) 142 of the network interface 140 of the grill 100 to transmit data and/or information, which may include one or more notification(s) (e.g., one or more visible, audible, and/or tactile message(s) or alert(s)) to one or more of the remote device(s) 154 of FIG. 1.

The detection circuitry 148 of the controller 144 of FIG. 1 detects and/or determines one or more state(s), condition(s), operation(s), and/or event(s) associated with the grill 100 based on data, information, and/or signals received from one or more component(s) of the grill 100 that is/are operatively coupled to (e.g., in wired or wireless electrical communication with) the controller 144 of the grill 100. For example, the detection circuitry 148 may include valve detection circuitry configured to detect and/or determine a relative position of the fuel source valve 108, the first burner valve 112, and/or the second burner valve 114 of the grill 100 based on one or more instruction(s), command(s), and/or signal(s) generated at the control circuitry 146 of the controller 144 and/or transmitted to the fuel source valve 108, the first burner valve 112, and/or the second burner valve 114.

The detection circuitry 148 may additionally or alternatively include encoder detection circuitry configured to detect and/or determine a relative position (e.g., a relative rotational position) of the first control knob 122 and/or the second control knob 126 of the grill 100 based on data, information, and/or signals received from corresponding ones of the first encoder 120 and/or the second encoder 124 of the grill 100. The detection circuitry 148 may additionally or alternatively include temperature detection circuitry configured to detect and/or determine one or more temperature state(s), condition(s), operation(s), and/or event(s) associated with the grill 100 (e.g., that a temperature of the cooking chamber 302 of the grill 100 is either above or below a predetermined temperature threshold) based on data, information, and/or signals received from the temperature sensor 128 of the grill 100. The detection circuitry 148 may additionally or alternatively include flame detection circuitry configured to detect and/or determine the presence or the absence of a flame at the first burner 102 and/or the second burner 104 of the grill 100 based on data, information, and/or signals received from one or more of the flame sensor(s) 130 of the grill 100.

The detection circuitry 148 may additionally or alternatively include user interface detection circuitry configured to detect and/or determine one or more user interface state(s), condition(s), operation(s), and/or event(s) associated with the grill 100 (e.g., that a user has interacted with one or more of the input device(s) 136 of the user interface 134, that a user has failed to interact with one or more of the input device(s) 136 of the user interface 134, etc.) based on data, information, and/or signals received from the user interface 134 of the grill 100. The detection circuitry 148 may additionally or alternatively include network interface detection circuitry configured to detect and/or determine one or more network interface state(s), condition(s), operation(s), and/or event(s) associated with the grill 100 (e.g., that one or more of the communication device(s) 142 of the network interface 140 has received data, information, and/or signals indicating that a user has interacted with one or more input device(s) of one or more of the remote device(s) 154, that one or more of the communication device(s) 142 of the network interface 140 has failed to receive data, information, and/or signals indicating that a user has interacted with one or more input device(s) of one or more of the remote device(s) 154, etc.) based on data, information, and/or signals received from the network interface 140 of the grill 100.

The cook program circuitry 150 of the controller 144 of FIG. 1 instructs, commands, signals, and/or otherwise causes the control system of the grill 100 of FIG. 1 to implement (e.g., execute) a selected cook program (e.g., the ordered steps of a cook program specified by and/or otherwise corresponding to the cook program selection received at the grill 100). In connection with the implementation (e.g., execution) of the selected cook program, the cook program circuitry 150 manages and/or controls the advancement and/or progression of a series of ordered steps of the cook program, with the ordered steps including a combination of: (1) fully-automated steps that can be performed (e.g., at the direction of the control circuitry 146 of the controller 144 of FIG. 1, under the management or control of the cook program circuitry 150 of the controller 144) without requiring user interaction with any component(s) of the grill 100; and (2) food movement steps that require user interaction to add, remove, and/or reposition (e.g., flip, rotate, relocate, and/or otherwise move) one or more item(s) of food to, from, and/or within the cooking chamber 302 of the grill 100. In some examples, one or more of such food movement step(s) may necessarily be preceded by a corresponding lid-opening step that requires user interaction to move the lid 204 of the grill 100 relative to the cookbox 202 of the grill 100 from a closed position (e.g., the closed position 200 of FIG. 2) to or toward an open position (e.g., the open position 300 of FIG. 3), thereby enabling the user of the grill 100 to access the cooking chamber 302 of the grill 100 for a specific purpose associated with the corresponding food movement step.

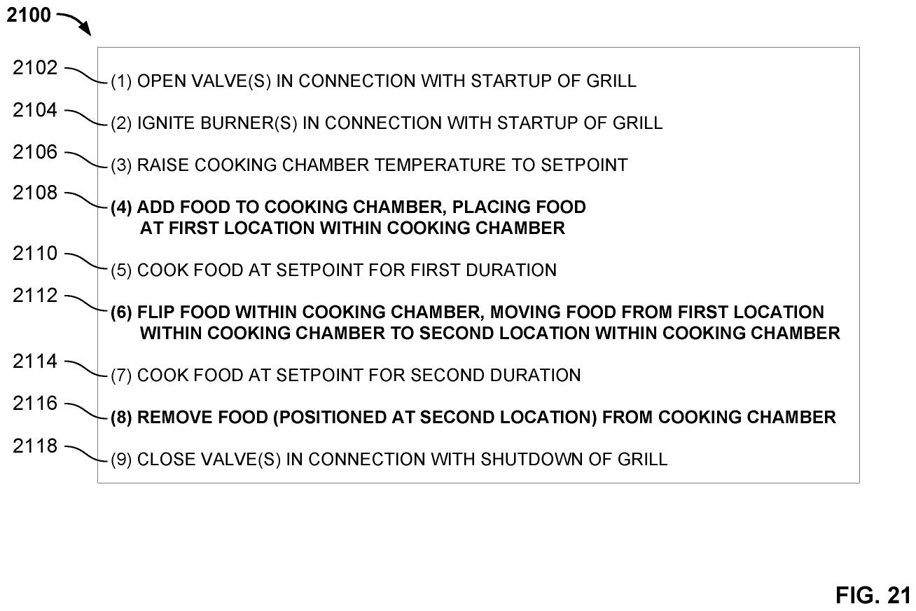

FIG. 21 is a logical representation of an example cook program 2100 to be implemented by the control system of the grill 100 of FIG. 1. The cook program 2100 of FIG. 21 comprises nine ordered steps, instructions, and/or operations including an example first step 2102, an example second step 2104, an example third step 2106, an example fourth step 2108, an example fifth step 2110, an example sixth step 2112, an example seventh step 2114, an example eighth step 2116, and an example ninth step 2118. In other examples, the cook program 2100 of FIG. 21 can include a different number (e.g., less than nine or greater than nine) of ordered steps, instructions, and/or operations.

In the illustrated example of FIG. 21, the first step 2102, the second step 2104, the third step 2106, the fifth step 2110, the seventh step 2114, and the ninth step 2118 are fully-automated steps capable of being implemented by the controller 144 and/or, more, generally, by the control system of the grill 100 of FIG. 1 in a fully-automated manner without requiring user interaction with any component(s) of the grill 100. For example, in connection with performing the first step 2102 of the cook program 2100 of FIG. 21, the control circuitry 146 of the controller 144 of FIG. 1 can instruct, command, signal, and/or otherwise cause the first burner valve 112 and/or the second burner valve 114 of FIG. 1 to open. As another example, in connection with performing the second step 2104 of the cook program 2100 of FIG. 21, the control circuitry 146 of the controller 144 of FIG. 1 can instruct, command, signal, and/or otherwise cause the first ignitor 116 and/or the second ignitor 118 of FIG. 1 to ignite corresponding ones of the first burner 102 and/or the second burner 104. As another example, in connection with performing the third step 2106 of the cook program 2100 of FIG. 21, the control circuitry 146 of the controller 144 of FIG. 1 can instruct, command, signal, and/or otherwise cause the first burner valve 112 and/or the second burner valve 114 of FIG. 1 to one or more positions that facilitate raising the temperature within the cooking chamber 302 of the grill 100 to a setpoint temperature defined by the cook program 2100. As another example, in connection with performing the fifth step 2110 of the cook program 2100 of FIG. 21, the control circuitry 146 of the controller 144 of FIG. 1 can instruct, command, signal, and/or otherwise cause the first burner valve 112 and/or the second burner valve 114 of FIG. 1 to one or more positions that facilitate maintaining the setpoint temperature within the cooking chamber 302 of the grill 100 for a first duration (e.g., a first period of time) defined by the cook program 2100.

By contrast, the fourth step 2108, the sixth step 2112, and the eighth step 2116 of the cook program 2100 are food movement steps that cannot be implemented by the control system of the grill 100 in a fully-automated manner. In this regard, each food movement step of the cook program 2100 requires a user of the grill 100 to add, remove, and/or reposition (e.g., flip, rotate, relocate, and/or otherwise move) one or more item(s) of food to, from, and/or within the cooking chamber 302 of the grill 100. For example, in connection with performing the fourth step 2108 of the cook program 2100 of FIG. 21, the user of the grill 100 is required to add one or more item(s) of food to the cooking chamber 302 of the grill 100, with the user being instructed to place the food item(s) at a first location within the cooking chamber 302. As another example, in connection with performing the sixth step 2112 of the cook program 2100 of FIG. 21, the user of the grill 100 is required to (1) flip the food item(s) within the cooking chamber 302 of the grill, with the user being instructed to move the food item(s) (e.g., as part of the flipping operation) from the first location within the cooking chamber 302 to a second location within the cooking chamber 302. As another example, in connection with performing the eighth step 2116 of the cook program 2100 of FIG. 21, the user of the grill 100 is required to remove the food item(s) (e.g., positioned at the second location) from the cooking chamber 302 of the grill 100. In each such example, the user's performance of the identified food movement step may require that the user of the grill 100 first moves the lid 204 of the grill 100 relative to the cookbox 202 of the grill 100 from a closed position (e.g., the closed position 200 of FIG. 2) to or toward an open position (e.g., the open position 300 of FIG. 3), thereby enabling the user of the grill 100 to access the cooking chamber 302 of the grill 100 for the specific purpose associated with the corresponding food movement step.

In the illustrated example of FIG. 21, the referenced first and second locations within the cooking chamber 302 of the grill 100 are specific area(s) and/or location(s) within the cooking chamber 302 that are identifiable in relation to one or more structural component(s) of the grill 100 that are located within and/or otherwise associated with the cooking chamber 302. For example, the first location may be identifiable as an area occupied by a first cooking grate of the grill 100, and the second location may be identifiable as an area occupied by a second cooking grate of the grill 100, with the first cooking grate and the second cooking grate both being located within the cooking chamber 302 of the grill 100. As another example, the first location may be identifiable as an area (e.g., of a cooking grate) directly above and/or directly over the first burner 102 of the grill 100, and the second location may be identifiable as an area (e.g., of a cooking grate) directly above and/or directly over the second burner 104 of the grill 100, with the first burner 102 and the second burner 104 both being located within the cooking chamber 302 of the grill 100. As another example, the first location may be identifiable as an area (e.g., of a cooking grate) directly above and/or directly over the first burner 102 of the grill 100, and the second location may be identifiable as area (e.g., of a cooking grate) that is adjacent the area associated with the first location, but which is not directly above and/or not directly over the first burner 102 of the grill 100.

When implementing (e.g., executing) a selected cook program, the cook program circuitry 150 of FIG. 1 determines whether the ordered steps of the cook program have advanced to a food movement step (e.g., a step that requires a user of the grill 100 to add, remove, and/or reposition (e.g., flip, rotate, relocate, and/or otherwise move) one or more item(s) of food to, from, and/or within the cooking chamber 302 of the grill 100). For example, the cook program circuitry 150 may determine that the ordered steps of the cook program have advanced to one of the food movement steps represented by the fourth step 2108, the sixth step 2112, or the eighth step 2116 of the cook program 2100 of FIG. 21. In instances where the cook program circuitry 150 determines that the ordered steps of the cook program have not yet advanced to a food movement step, the cook program circuitry 150 continues with the implementation (e.g., execution) of one or more fully-automated step(s) from among the ordered steps of the cook program, and does so until the ordered steps of the cook program have advanced to a food movement step.

Conversely, in instances where the cook program circuitry 150 determines that the ordered steps of the cook program have advanced to a food movement step, the cook program circuitry 150 generates one or more location-based food movement notification(s) associated with the current food movement step (e.g., the food movement step to which the cook program has currently advanced). For example, in response to the cook program circuitry 150 determining that the ordered steps of the cook program 2100 of FIG. 21 have advanced to the fourth step 2108 of the cook program 2100, the cook program circuitry 150 generates one or more location-based food movement notification(s) associated with the first location within the cooking chamber 302 of the grill 100 to which the food item(s) are to be added. As another example, in response to the cook program circuitry 150 determining that the ordered steps of the cook program 2100 of FIG. 21 have advanced to the sixth step 2112 of the cook program 2100, the cook program circuitry 150 generates one or more location-based food movement notification(s) associated with the first location and/or the second location within the cooking chamber 302 of the grill 100 from and/or to which the food item(s) are to be moved. As another example, in response to the cook program circuitry 150 determining that the ordered steps of the cook program 2100 of FIG. 21 have advanced to the eighth step 2116 of the cook program 2100, the cook program circuitry 150 generates one or more location-based food movement notification(s) associated with the second location within the cooking chamber 302 of the grill 100 from which the food item(s) are to be removed.

The cook program circuitry 150 of FIG. 1 instructs, commands, signals, and/or otherwise causes the location-based food movement notification(s) associated with the current food movement step to be presented locally at the grill 100 such that the location-based food movement notification(s), when presented, provide(s) the user with an intuitive “at-the-cookbox” visual identification (e.g., presented via one or more of the lighting module(s) 132 of the grill 100) of one or more area(s) and/or location(s) within the cooking chamber 302 of the grill 100 at which the associated food movement step is to occur. For example, when presented at the grill 100, the location-based food movement notification(s) generated by the cook program circuitry 150 in connection with the fourth step 2108 of the cook program 2100 of FIG. 21 provide(s) the user with a visual indication (e.g., a viewable, light-based indication presented via one or more of the lighting module(s) 132 of the grill 100) which intuitively informs the user that one or more food item(s) are to be added to the cooking chamber 302 of the grill 100 at an area and/or location within the cooking chamber 302 corresponding to the first location associated with the fourth step 2108. As another example, when presented at the grill 100, the location-based food movement notification(s) generated by the cook program circuitry 150 in connection with the sixth step 2112 of the cook program 2100 of FIG. 21 provide(s) the user with a visual indication (e.g., a viewable, light-based indication presented via one or more of the lighting module(s) 132 of the grill 100) which intuitively informs the user that the food item(s) are to be flipped within the cooking chamber 302 of the grill 100 from an area and/or location within the cooking chamber 302 corresponding to the first location associated with the sixth step 2112 to an area and/or location within the cooking chamber 302 corresponding to the second location associated with the sixth step 2112. As another example, when presented at the grill 100, the location-based food movement notification(s) generated by the cook program circuitry 150 in connection with the eighth step 2116 of the cook program 2100 of FIG. 21 provide(s) the user with a visual indication (e.g., a viewable, light-based indication presented via one or more of the lighting module(s) 132 of the grill 100) which intuitively informs the user that the food item(s) located at an area and/or location corresponding to the second location associated with the eighth step 2116 are to be removed from the cooking chamber 302 of the grill 100.

The presentation of the aforementioned location-based food movement notification(s) via the lighting module(s) 132 of the grill 100 can be implemented via any of the illumination techniques and/or illumination patterns described above. Such illumination techniques and illumination patterns can include, without limitation: (1) illuminating and/or pulsing one or more light source(s) of a lighting module 132 that is spatially aligned (e.g., in front-to-rear and/or top-to-bottom alignment along a vertical plane) with a portion and/or area of a corresponding one of the cooking grate(s) (e.g., a portion and/or area of the cooking grate 304) located within the cooking chamber 302 of the grill 100 to indicate a location and/or area of the cooking chamber 302 at which the associated food movement step is to be performed, (2) illuminating and/or pulsing one or more light source(s) of a lighting module 132 that is spatially aligned (e.g., in front-to-rear and/or top-to-bottom alignment along a vertical plane) with a corresponding one of the burner(s) (e.g., the first burner 102 or the second burner 104) located within the cooking chamber 302 of the grill 100 to indicate a location and/or area within the cooking chamber 302 at which the associated food movement step is to be performed; (3) illuminating a plurality of light sources of a lighting module 132 according to a direction-based illumination pattern (e.g., the illumination pattern 1134 of FIG. 11) to indicate a direction in which the associated food movement step is to be performed; and/or (4) illuminating a plurality of light sources of a lighting module 132 according to a time-based illumination pattern (e.g., the illumination pattern 1034 of FIG. 10) to indicate a time at which the associated food movement step is to be performed.

Subsequent to the local (e.g., at the grill 100) presentation of the location-based food movement notification(s) associated with the current food movement step, and as a further response to determining that the ordered steps of the cook program have advanced to a food movement step, the cook program circuitry 150 invokes the detection circuitry 148 of FIG. 1 to assist the cook program circuitry 150 in determining when to advance the ordered steps of cook program from the current food movement step to a next step (e.g., a fully-automated step) of the cook program. The detection circuitry 148 of the controller 144 of FIG. 1 determines and/or detects whether a current food movement step of a cook program has been performed. For example, the detection circuitry 148 may determine that the current food movement step of the cook program has been performed based on a user input, a user selection, and/or a user interaction (e.g., a press, a push, a pull, a rotation, a click, a flip, a swipe, a touch, etc.) to, of, and/or with one or more of the input device(s) 136 (e.g., a button, a dial, a knob, a switch, a touchscreen, etc.) of the user interface 134 of FIG. 1. As another example, the detection circuitry 148 may determine that the current food movement step of the cook program has been performed based on a user input, a user selection, and/or a user interaction (e.g., a press, a push, a pull, a rotation, a click, a flip, a swipe, a touch, etc.) to, of, and/or with one or more input device(s) (e.g., a button, a dial, a knob, a switch, a touchscreen, etc.) of one of the remote device(s) 154 of FIG. 1, as received and/or detected via the network interface 140 of FIG. 1. As another example, the detection circuitry 148 may determine that the current food movement step of the cook program has been performed based on lid position data (e.g., as sensed, measured, and/or detected by a lid position sensor of the grill 100) indicating that the lid 204 of the grill 100 has moved relative to the cookbox 202 of the grill 100 from a closed position (e.g., the closed position 200 of FIG. 2) to or toward an open position (e.g., the open position 300 of FIG. 3). As another example, the detection circuitry 148 may determine that the current food movement step of the cook program has been performed based on temperature data (e.g., as sensed, measured, and/or detected by the temperature sensor 128 of the grill 100) indicating a decrease (e.g., a rapid decline) in the temperature of the cooking chamber 302 of the grill 100, with said decrease being indicative of the lid 204 of the grill 100 having moved relative to the cookbox 202 of the grill 100 from a closed position (e.g., the closed position 200 of FIG. 2) to or toward an open position (e.g., the open position 300 of FIG. 3).

In response to the detection circuitry 148 of FIG. 1 determining and/or detecting that the current food movement step of the cook program has been performed, the cook program circuitry 150 of FIG. 1 advances the ordered steps of the cook program from the current food movement step to a next step (e.g., a fully-automated step) of the cook program. For example, the cook program circuitry 150 may advance the ordered steps of the cook program from the food movement step represented by the fourth step 2108 of the cook program 2100 of FIG. 21 to the fully-automated step represented by the fifth step 2110 of the cook program 2100 of FIG. 21. As another example, the cook program circuitry 150 may advance the ordered steps of the cook program from the food movement step represented by the sixth step 2112 of the cook program 2100 of FIG. 21 to the fully-automated step represented by the seventh step 2114 of the cook program 2100 of FIG. 21. As yet another example, the cook program circuitry 150 may advance the ordered steps of the cook program from the food movement step represented by the eighth step 2116 of the cook program 2100 of FIG. 21 to the fully-automated step represented by the ninth step 2118 of the cook program 2100 of FIG. 21.

The above-described operations of the cook program circuitry 150 and the detection circuitry 148 of FIG. 1 continue in an iterative and/or repeated manner until the cook program circuitry 150 determines that all of the food movement steps (e.g., each of the fourth step 2108, the sixth step 2112, and the eighth step 2116 of the cook program 2100 of FIG. 21) from among the ordered steps of the selected cook program have been performed. Upon determining that all of the food movement steps from among the ordered steps of the selected cook program have been performed, the cook program circuitry 150 continues the implementation (e.g., execution) of any remaining fully-automated steps (e.g., the ninth step 2118 of the cook program 2100 of FIG. 21) from among the ordered steps of the selected cook program, and does so until the cook program circuitry 150 determines that all of the steps (including both the food movement steps and the fully-automated steps) from among the ordered steps of the cook program have been performed.

The memory 152 of FIG. 1 can be implemented by any type(s) and/or any number(s) of storage device(s) such as a storage drive, a flash memory, a read-only memory (ROM), a random-access memory (RAM), a cache and/or any other physical storage medium in which information is stored for any duration (e.g., for extended time periods, permanently, brief instances, for temporarily buffering, and/or for caching of the information). The information stored in the memory 152 of FIG. 1 can be stored in any file and/or data structure format, organization scheme, and/or arrangement.

The memory 152 stores data sensed, measured, detected, generated, accessed, input, output, transmitted, and/or received by, to, and/or from the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), the controller 144 (e.g., including the control circuitry 146, the detection circuitry 148, and the cook program circuitry 150), the remote device(s) 154, and/or, more generally, the control system of the grill 100 of FIG. 1. The memory 152 also stores instructions (e.g., machine-readable instructions) and associated data corresponding to the processes, protocols, programs, sequences, and/or methods described below in connection with FIG. 21. The memory 152 of FIG. 1 is accessible to one or more of the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), the controller 144 (e.g., including the control circuitry 146, the detection circuitry 148, and the cook program circuitry 150), the remote device(s) 154, and/or, more generally, the control system of the grill 100 of FIG. 1.

While an example manner of implementing the control system of the grill 100 is illustrated in FIG. 1, one or more of the elements, processes, and/or devices illustrated in FIG. 1 may be combined, divided, re-arranged, omitted, eliminated, and/or implemented in any other way. Further, the example fuel source valve 108, the example first burner valve 112, the example second burner valve 114, the example first ignitor 116, the example second ignitor 118, the example first encoder 120, the example second encoder 124, the example temperature sensor 128, the example flame sensor(s) 130, the example lighting module(s) 132, the example user interface 134 (e.g., including the example input device(s) 136 and the example output device(s) 138), the example network interface 140 (e.g., including the example communication device(s) 142), the example controller 144 (e.g., including the example control circuitry 146, the example detection circuitry 148, and the example cook program circuitry 150), the example memory 152, and/or, more generally, the control system of the grill 100 of FIG. 1, may be implemented by hardware alone or by hardware in combination with software and/or firmware. Thus, for example, any of the example fuel source valve 108, the example first burner valve 112, the example second burner valve 114, the example first ignitor 116, the example second ignitor 118, the example first encoder 120, the example second encoder 124, the example temperature sensor 128, the example flame sensor(s) 130, the example lighting module(s) 132, the example user interface 134 (e.g., including the example input device(s) 136 and the example output device(s) 138), the example network interface 140 (e.g., including the example communication device(s) 142), the example controller 144 (e.g., including the example control circuitry 146, the example detection circuitry 148, and the example cook program circuitry 150), the example memory 152, and/or, more generally, the control system of the grill 100 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example control system of the grill of FIG. 1 may include one or more elements, processes, and/or devices in addition to, or instead of, those illustrated in FIG. 1, and/or may include more than one of any or all of the illustrated elements, processes, and devices.

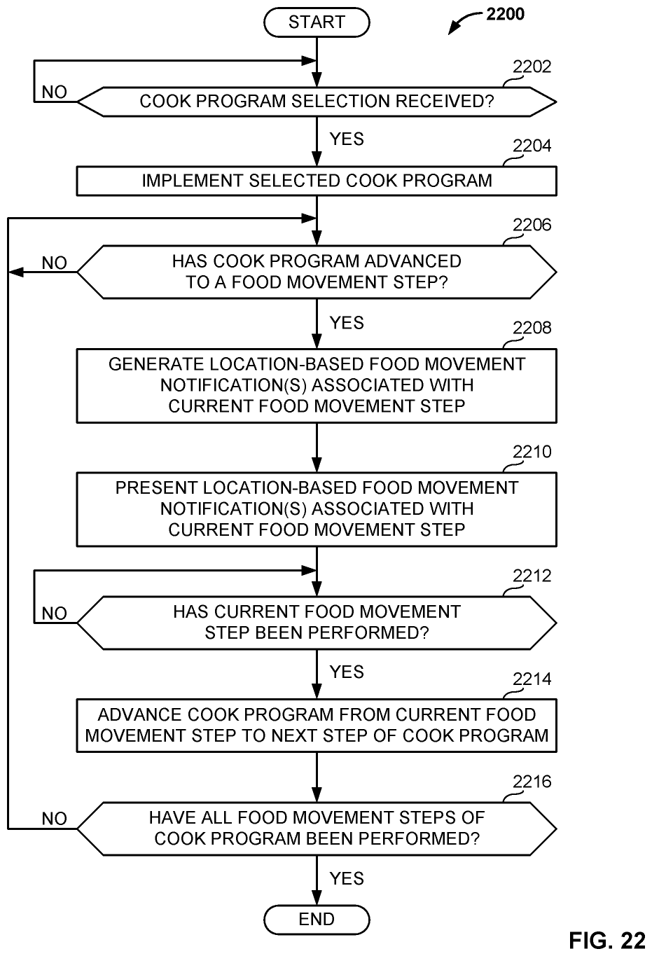

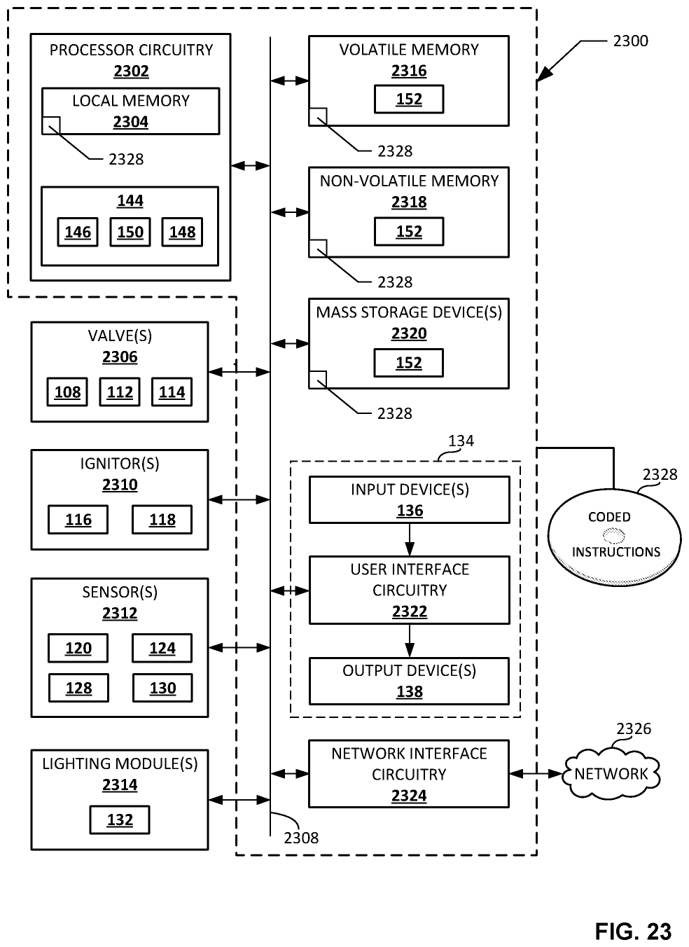

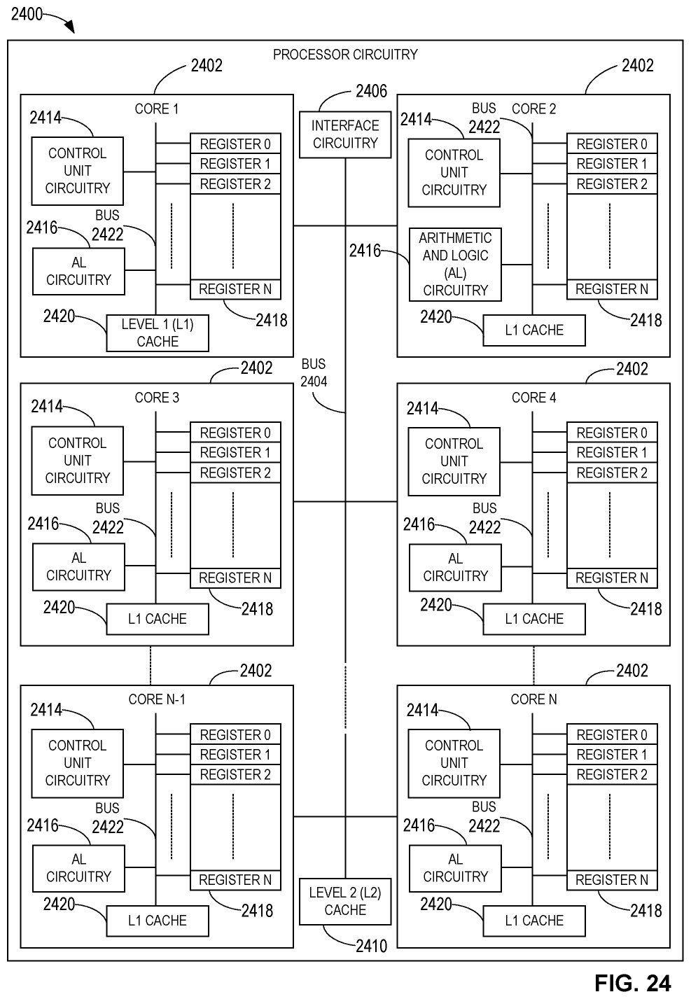

A flowchart representing example hardware logic circuitry, machine-readable instructions, hardware implemented state machines, and/or any combination thereof for implementing the grill 100 of FIG. 1 are shown in FIG. 22. The machine-readable instructions may be one or more executable program(s) or portion(s) thereof for execution by processor circuitry, such as the processor circuitry 2302 shown in the example processor platform 2300 discussed below in connection with FIG. 23 and/or the example processor circuitry discussed below in connection with FIGS. 24 and/or 25. The program(s) may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program(s) and/or the portion(s) thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although an example program is described with reference to the flowchart illustrated in FIG. 22, many other methods of implementing the example grill 100 may alternatively be used. For example, the order of execution of the blocks may be changed, and/or some of the blocks described may be changed, eliminated, or combined. Additionally, or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine-executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or any other machine. For example, the machine-readable instructions may be stored in multiple parts, which are individually compressed, encrypted, and/or stored on separate computing devices, wherein the parts when decrypted, decompressed, and/or combined form a set of machine-executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or any other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 22 may be implemented using executable instructions (e.g., computer and/or machine-readable instructions) stored on one or more non-transitory computer and/or machine-readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable medium” and “non-transitory computer-readable storage medium” are expressly defined to include any type of computer-readable storage device and/or storage disk and to exclude propagating signals and to exclude transmission media.

The terms “including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

FIG. 22 is a flowchart representative of example machine-readable instructions and/or example operations 2200 that may be executed by processor circuitry to implement a location-based food movement notification process of the grill 100 of FIG. 1. The machine-readable instructions and/or operations 2200 of FIG. 22 begin at Block 2202 when the controller 144 of FIG. 1 determines whether a cook program selection has been received. For example, the controller 144 may determine that a cook program selection has been received based on a user input, a user selection, and/or a user interaction (e.g., a press, a push, a pull, a rotation, a click, a flip, a swipe, a touch, etc.) to, of, and/or with one or more of the input device(s) 136 (e.g., a button, a dial, a knob, a switch, a touchscreen, etc.) of the user interface 134 of FIG. 1. As another example, the controller 144 may determine that a cook program selection has been received based on a user input, a user selection, and/or a user interaction (e.g., a press, a push, a pull, a rotation, a click, a flip, a swipe, a touch, etc.) to, of, and/or with one or more input device(s) (e.g., a button, a dial, a knob, a switch, a touchscreen, etc.) of one of the remote device(s) 154 of FIG. 1, as received and/or detected via the network interface 140 of FIG. 1. If the controller 144 determines at Block 2202 that a cook program selection has not been received, control of the machine-readable instructions and/or operations 2200 of FIG. 22 remains at Block 2202. If the controller 144 instead determines at Block 2202 that a cook program selection has been received, control of the machine-readable instructions and/or operations 2200 of FIG. 22 proceeds to Block 2204.

At Block 2204, the cook program circuitry 150 of the controller 144 of FIG. 1 instructs, commands, signals, and/or otherwise causes the control system of the grill 100 of FIG. 1 to implement (e.g., to execute) the selected cook program (e.g., a cook program specified by and/or otherwise corresponding to the cook program selection received at Block 2202). For example, the cook program circuitry 150 may instruct, command, signal, and/or otherwise cause the control system of the grill 100 of FIG. 1 to implement the ordered steps of the cook program 2100 of FIG. 21. In connection with the implementation (e.g., the execution) of the selected cook program, the cook program circuitry 150 manages and/or controls the advancement and/or progression of the ordered steps of the cook program, with the ordered steps including a combination of: (1) fully-automated steps that can be performed (e.g., at the direction of the control circuitry 146 of the controller 144 of FIG. 1, under the management or control of the cook program circuitry 150 of the controller 144) without requiring user interaction with any component(s) of the grill 100; and (2) food movement steps that require user interaction to add, remove, and/or reposition (e.g., flip, rotate, relocate, and/or otherwise move) one or more item(s) of food to, from, and/or within the cooking chamber 302 of the grill 100. Following Block 2204, control of the example machine-readable instructions and/or operations 2200 of FIG. 22 proceeds to Block 2206.

At Block 2206, the cook program circuitry 150 of the controller 144 of FIG. 1 determines whether the cook program has advanced to a food movement step (e.g., a step that requires the user of the grill 100 to add, remove, and/or reposition (e.g., flip, rotate, relocate, and/or otherwise move) one or more item(s) of food to, from, and/or within the cooking chamber 302 of the grill 100). For example, the cook program circuitry 150 may determine that the cook program has advanced to one of the food movement steps represented by the fourth step 2108, the sixth step 2112, or the eighth step 2116 of the cook program 2100 of FIG. 21. If the cook program circuitry 150 determines at Block 2206 that the cook program has not advanced to a food movement step, control of the machine-readable instructions and/or operations 2200 of FIG. 22 remains at Block 2206, where the implementation (e.g., the execution) of the ordered steps of the cook program continues until the cook program has advanced to a food movement step. If the cook program circuitry 150 instead determines at Block 2206 that the cook program has advanced to a food movement step, control of the machine-readable instructions and/or operations 2200 of FIG. 22 proceeds to Block 2208.

At Block 2208, the cook program circuitry 150 of the controller 144 of FIG. 1 generates one or more location-based food movement notification(s) associated with the current food movement step (e.g., the food movement step to which the cook program has currently advanced). For example, in response to the cook program circuitry 150 determining that the ordered steps of the cook program 2100 of FIG. 21 have advanced to the fourth step 2108 of the cook program 2100, the cook program circuitry 150 generates one or more location-based food movement notification(s) associated with the first location within the cooking chamber 302 of the grill 100 to which the food item(s) are to be added. As another example, in response to the cook program circuitry 150 determining that the ordered steps of the cook program 2100 of FIG. 21 have advanced to the sixth step 2112 of the cook program 2100, the cook program circuitry 150 generates one or more location-based food movement notification(s) associated with the first location and/or the second location within the cooking chamber 302 of the grill 100 from and/or to which the food item(s) are to be moved. As another example, in response to the cook program circuitry 150 determining that the ordered steps of the cook program 2100 of FIG. 21 have advanced to the eighth step 2116 of the cook program 2100, the cook program circuitry 150 generates one or more location-based food movement notification(s) associated with the second location within the cooking chamber 302 of the grill 100 from which the food item(s) are to be removed. Following Block 2208, control of the example machine-readable instructions and/or operations 2200 of FIG. 22 proceeds to Block 2210.

At Block 2210, the cook program circuitry 150 of the controller 144 of FIG. 1 instructs, commands, signals, and/or otherwise causes the location-based food movement notification(s) associated with the current food movement step to be presented locally at the grill 100. In some examples, the location-based food movement notification(s), when presented, provide(s) the user with an intuitive “at-the-cookbox” visual identification (e.g., presented via one or more of the lighting module(s) 132 of the grill 100) of one or more area(s) and/or location(s) within the cooking chamber 302 of the grill 100 at which the associated food movement step is to occur. For example, when presented at the grill 100, the location-based food movement notification(s) generated by the cook program circuitry 150 in connection with the fourth step 2108 of the cook program 2100 of FIG. 21 provide(s) the user with a visual indication (e.g., a viewable, light-based indication presented via one or more of the lighting module(s) 132 of the grill 100) which intuitively informs the user that one or more food item(s) are to be added to the cooking chamber 302 of the grill 100 at an area and/or location within the cooking chamber 302 corresponding to the first location associated with the fourth step 2108. As another example, when presented at the grill 100, the location-based food movement notification(s) generated by the cook program circuitry 150 in connection with the sixth step 2112 of the cook program 2100 of FIG. 21 provide(s) the user with a visual indication (e.g., a viewable, light-based indication presented via one or more of the lighting module(s) 132 of the grill 100) which intuitively informs the user that the food item(s) are to be flipped within the cooking chamber 302 of the grill 100 from an area and/or location within the cooking chamber 302 corresponding to the first location associated with the sixth step 2112 to an area and/or location within the cooking chamber 302 corresponding to the second location associated with the sixth step 2112. As another example, when presented at the grill 100, the location-based food movement notification(s) generated by the cook program circuitry 150 in connection with the eighth step 2116 of the cook program 2100 of FIG. 21 provide(s) the user with a visual indication (e.g., a viewable, light-based indication presented via one or more of the lighting module(s) 132 of the grill 100) which intuitively informs the user that the food item(s) located at an area and/or location corresponding to the second location associated with the eighth step 2116 are to be removed from the cooking chamber 302 of the grill 100.

The presentation of the location-based food movement notification(s) via the lighting module(s) 132 of the grill 100 (e.g., in conjunction with the operations of Block 2210) can be implemented via any of the illumination techniques and/or illumination patterns described above. Such illumination techniques and illumination patterns can include, without limitation: (1) illuminating and/or pulsing one or more light source(s) of a lighting module 132 that is spatially aligned (e.g., in front-to-rear and/or top-to-bottom alignment along a vertical plane) with a portion and/or area of a corresponding one of the cooking grate(s) (e.g., a portion and/or area of the cooking grate 304) located within the cooking chamber 302 of the grill 100 to indicate a location and/or area of the cooking chamber 302 at which the associated food movement step is to be performed, (2) illuminating and/or pulsing one or more light source(s) of a lighting module 132 that is spatially aligned (e.g., in front-to-rear and/or top-to-bottom alignment along a vertical plane) with a corresponding one of the burner(s) (e.g., the first burner 102 or the second burner 104) located within the cooking chamber 302 of the grill 100 to indicate a location and/or area within the cooking chamber 302 at which the associated food movement step is to be performed; (3) illuminating a plurality of light sources of a lighting module 132 according to a direction-based illumination pattern (e.g., the illumination pattern 1134 of FIG. 11) to indicate a direction in which the associated food movement step is to be performed; and/or (4) illuminating a plurality of light sources of a lighting module 132 according to a time-based illumination pattern (e.g., the illumination pattern 1034 of FIG. 10) to indicate a time at which the associated food movement step is to be performed.

In some examples, one or more of the location-based food movement notification(s) associated with the current food movement step may be presented locally at the grill 100 (e.g., via one or more of the lighting module(s) 132 of the grill 100) for a predetermined duration (e.g., a predetermined presentation duration, as may be stored in the memory 152 of the grill 100). In other examples, one or more of the location-based food movement notification(s) associated with the current food movement step may be presented locally at the grill 100 (e.g., via one or more of the lighting module(s) 132 of the grill 100) until a countering event (e.g., determining that the current food movement step has been completed, receiving a request, command, and/or instruction to terminate the presentation of the location-based food movement notification(s), etc.) occurs. Following Block 2210, control of the example machine-readable instructions and/or operations 2200 of FIG. 22 proceeds to Block 2212.

At Block 2212, the detection circuitry 148 of the controller 144 of FIG. 1 determines whether the current food movement step of the cook program has been performed. For example, the detection circuitry 148 may determine that the current food movement step of the cook program has been performed based on a user input, a user selection, and/or a user interaction (e.g., a press, a push, a pull, a rotation, a click, a flip, a swipe, a touch, etc.) to, of, and/or with one or more of the input device(s) 136 (e.g., a button, a dial, a knob, a switch, a touchscreen, etc.) of the user interface 134 of FIG. 1. As another example, the detection circuitry 148 may determine that the current food movement step of the cook program has been performed based on a user input, a user selection, and/or a user interaction (e.g., a press, a push, a pull, a rotation, a click, a flip, a swipe, a touch, etc.) to, of, and/or with one or more input device(s) (e.g., a button, a dial, a knob, a switch, a touchscreen, etc.) of one of the remote device(s) 154 of FIG. 1, as received and/or detected via the network interface 140 of FIG. 1. As another example, the detection circuitry 148 may determine that the current food movement step of the cook program has been performed based on lid position data (e.g., as sensed, measured, and/or detected by a lid position sensor of the grill 100) indicating that the lid 204 of the grill 100 has moved relative to the cookbox 202 of the grill 100 from a closed position (e.g., the closed position 200 of FIG. 2) to or toward an open position (e.g., the open position 300 of FIG. 3). As another example, the detection circuitry 148 may determine that the current food movement step of the cook program has been performed based on temperature data (e.g., as sensed, measured, and/or detected by the temperature sensor 128 of the grill 100) indicating a decrease (e.g., a rapid decline) in the temperature of the cooking chamber 302 of the grill 100, with said decrease being indicative of the lid 204 of the grill 100 having moved relative to the cookbox 202 of the grill 100 from a closed position (e.g., the closed position 200 of FIG. 2) to or toward an open position (e.g., the open position 300 of FIG. 3). If the detection circuitry 148 determines at Block 2212 that the current food movement step of the cook program has not been performed, control of the machine-readable instructions and/or operations 2200 of FIG. 22 remains at Block 2212. If the detection circuitry 148 determines at Block 2212 that the current food movement step of the cook program has been performed, control of the machine-readable instructions and/or operations 2200 of FIG. 22 proceeds to Block 2214.

At Block 2214, the cook program circuitry 150 of the controller 144 of FIG. 1 advances the cook program from the current food movement step to a next step (e.g., a fully-automated step) of the cook program. For example, the cook program circuitry 150 may advance the food movement step represented by the fourth step 2108 of the cook program 2100 of FIG. 21 to the fully-automated step represented by the fifth step 2110 of the cook program 2100 of FIG. 21. As another example, the cook program circuitry 150 may advance the food movement step represented by the sixth step 2112 of the cook program 2100 of FIG. 21 to the fully-automated step represented by the seventh step 2114 of the cook program 2100 of FIG. 21. As yet another example, the cook program circuitry 150 may advance the food movement step represented by the eighth step 2116 of the cook program 2100 of FIG. 21 to the fully-automated step represented by the ninth step 2118 of the cook program 2100 of FIG. 21. Following Block 2214, control of the example machine-readable instructions and/or operations 2200 of FIG. 22 proceeds to Block 2216.

At Block 2216, the cook program circuitry 150 of the controller 144 of FIG. 1 determines whether all of the food movement steps of the cook program have been performed. For example, if the current food movement step of the cook program that is determined to have been performed at Block 2212 is one of the food movement steps represented by the fourth step 2108 or the sixth step 2112 of the cook program 2100 of FIG. 21, the cook program circuitry 150 determines that one or more food movement step(s) of the cook program (e.g., at least the food movement step represented by the eighth step 2116 of the cook program 2100 of FIG. 21) has/have not yet been performed. Conversely, if the current food movement step of the cook program that is determined to have been performed at Block 2212 is the food movement step represented by the eighth step 2116 of the cook program 2100 of FIG. 21, the cook program circuitry 150 instead determines that all of the food movement steps of the cook program have been performed. If the cook program circuitry 150 determines at Block 2216 that less than all of the food movement steps of the cook program have been performed, control of the machine-readable instructions and/or operations 2200 of FIG. 22 returns to Block 2206, where the implementation (e.g., the execution) of the ordered steps of the cook program continues until the cook program has advanced to the next food movement step. If the cook program circuitry 150 instead determines at Block 2216 that all of the food movement steps of the cook program have been performed, the machine-readable instructions and/or operations 2200 of FIG. 22 end.

FIG. 23 is a block diagram of an example processor platform 2300 including processor circuitry structured to execute and/or instantiate the machine-readable instructions and/or operations 2200 of FIG. 22 to implement the grill 100 of FIG. 1. The processor platform 2300 of the illustrated example includes processor circuitry 2302. The processor circuitry 2302 of the illustrated example is hardware. For example, the processor circuitry 2302 can be implemented by one or more integrated circuit(s), logic circuit(s), FPGA(s), microprocessor(s), CPU(s), GPU(s), DSP(s), and/or microcontroller(s) from any desired family or manufacturer. The processor circuitry 2302 may be implemented by one or more semiconductor based (e.g., silicon based) device(s). In this example, the processor circuitry 2302 implements the controller 144 of FIG. 1, including the control circuitry 146, the detection circuitry 148, and the cook program circuitry 150 of the controller 144.

The processor circuitry 2302 of the illustrated example includes a local memory 2304 (e.g., a cache, registers, etc.). The processor circuitry 2302 is in electrical communication with one or more valve(s) 2306 via a bus 2308. In this example, the valve(s) 2306 include the fuel source valve 108, the first burner valve 112, and the second burner valve 114 of FIG. 1. The processor circuitry 2302 is also in electrical communication with one or more ignitor(s) 2310 via the bus 2308. In this example, the ignitor(s) 2310 include the first ignitor 116 and the second ignitor 118 of FIG. 1. The processor circuitry 2302 is also in electrical communication with one or more sensor(s) 2312 via the bus 2308. In this example, the sensor(s) 2312 include the first encoder 120, the second encoder 124, the temperature sensor 128, and the flame sensor(s) 130 of FIG. 1. The processor circuitry 2302 is also in electrical communication with one or more lighting module(s) 2314 via the bus 2308. In this example, the lighting module(s) 2314 include the lighting module(s) 132 of FIG. 1.

The processor circuitry 2302 is also in electrical communication with a main memory via the bus 2308, with the main memory including a volatile memory 2316 and a non-volatile memory 2318. The volatile memory 2316 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2318 may be implemented by flash memory and/or any other desired type of memory device. Access to the main memory 2316, 2318 of the illustrated example is controlled by a memory controller.

The processor platform 2300 of the illustrated example also includes one or more mass storage device(s) 2320 to store software and/or data. Examples of such mass storage device(s) 2320 include magnetic storage devices, optical storage devices, floppy disk drives, HDDs, CDs, Blu-ray disk drives, redundant array of independent disks (RAID) systems, solid state storage devices such as flash memory devices, and DVD drives. In the illustrated example of FIG. 23, one or more of the volatile memory 2316, the non-volatile memory 2318, and/or the mass storage device(s) 2320 implement(s) the memory 152 of FIG. 1.

The processor platform 2300 of the illustrated example also includes user interface circuitry 2322. The user interface circuitry 2322 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. In the illustrated example, one or more input device(s) 136 are connected to the user interface circuitry 2322. The input device(s) 136 permit(s) a user to enter data and/or commands into the processor circuitry 2302. The input device(s) 136 can be implemented by, for example, one or more button(s), dial(s), knob(s), switch(es), touchscreen(s), audio sensor(s), microphone(s), image sensor(s), and/or camera(s). One or more output device(s) 138 are also connected to the user interface circuitry 2322 of the illustrated example. The output device(s) 138 can be implemented, for example, by one or more display device(s) (e.g., light emitting diode(s) (LED(s)), organic light emitting diode(s) (OLED(s)), liquid crystal display(s) (LCD(s)), cathode ray tube (CRT) display(s), in-plane switching (IPS) display(s), touchscreen(s), etc.), tactile output device(s), and/or speaker(s). The user interface circuitry 2322 of the illustrated example, thus, typically includes a graphics driver card, a graphics driver chip, and/or graphics processor circuitry such as a GPU. In the illustrated example of FIG. 23, the user interface circuitry 2322, the input device(s) 136, and the output device(s) 138 collectively implement the user interface 134 of FIG. 1.

The processor platform 2300 of the illustrated example also includes network interface circuitry 2324. The network interface circuitry 2324 includes one or more communication device(s) (e.g., transmitter(s), receiver(s), transceiver(s), modem(s), gateway(s), wireless access point(s), etc.) to facilitate exchange of data with external machines (e.g., computing devices of any kind, including the remote device(s) 154 of FIG. 1) by a network 2326. The communication can be by, for example, an Ethernet connection, a digital subscriber line (DSL) connection, a telephone line connection, a coaxial cable system, a satellite system, a wireless system, a cellular telephone system, an optical connection, etc. In the illustrated example of FIG. 23, the network interface circuitry 2324 implements the network interface 140 (e.g., including the communication device(s) 142) of FIG. 1.

Coded instructions 2328 including the above-described machine-readable instructions and/or operations 2200 of FIG. 22 may be stored the local memory 2304, in the volatile memory 2316, in the non-volatile memory 2318, on the mass storage device(s) 2320, and/or on a removable non-transitory computer-readable storage medium such as a flash memory stick, a dongle, a CD, or a DVD.

FIG. 24 is a block diagram of an example implementation of the processor circuitry 2302 of FIG. 23. In this example, the processor circuitry 2302 of FIG. 23 is implemented by a microprocessor 2400. For example, the microprocessor 2400 may implement multi-core hardware circuitry such as a CPU, a DSP, a GPU, an XPU, etc. Although it may include any number of example cores 2402 (e.g., 1 core), the microprocessor 2400 of this example is a multi-core semiconductor device including N cores. The cores 2402 of the microprocessor 2400 may operate independently or may cooperate to execute machine-readable instructions. For example, machine code corresponding to a firmware program, an embedded software program, or a software program may be executed by one of the cores 2402 or may be executed by multiple ones of the cores 2402 at the same or different times. In some examples, the machine code corresponding to the firmware program, the embedded software program, or the software program is split into threads and executed in parallel by two or more of the cores 2402. The software program may correspond to a portion or all of the machine-readable instructions and/or operations 2200 represented by the flowchart of FIG. 22.

The cores 2402 may communicate by an example bus 2404. In some examples, the bus 2404 may implement a communication bus to effectuate communication associated with one(s) of the cores 2402. For example, the bus 2404 may implement at least one of an Inter-Integrated Circuit (I2C) bus, a Serial Peripheral Interface (SPI) bus, a PCI bus, or a PCIe bus. Additionally, or alternatively, the bus 2404 may implement any other type of computing or electrical bus. The cores 2402 may obtain data, instructions, and/or signals from one or more external devices by example interface circuitry 2406. The cores 2402 may output data, instructions, and/or signals to the one or more external devices by the interface circuitry 2406. Although the cores 2402 of this example include example local memory 2420 (e.g., Level 1 (L1) cache that may be split into an L1 data cache and an L1 instruction cache), the microprocessor 2400 also includes example shared memory 2410 that may be shared by the cores (e.g., Level 2 (L2_ cache)) for high-speed access to data and/or instructions. Data and/or instructions may be transferred (e.g., shared) by writing to and/or reading from the shared memory 2410. The local memory 2420 of each of the cores 2402 and the shared memory 2410 may be part of a hierarchy of storage devices including multiple levels of cache memory and the main memory (e.g., the main memory 2316, 2318 of FIG. 23). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 2402 may be referred to as a CPU, DSP, GPU, etc., or any other type of hardware circuitry. Each core 2402 includes control unit circuitry 2414, arithmetic and logic (AL) circuitry (sometimes referred to as an ALU) 2416, a plurality of registers 2418, the L1 cache 2420, and an example bus 2422. Other structures may be present. For example, each core 2402 may include vector unit circuitry, single instruction multiple data (SIMD) unit circuitry, load/store unit (LSU) circuitry, branch/jump unit circuitry, floating-point unit (FPU) circuitry, etc. The control unit circuitry 2414 includes semiconductor-based circuits structured to control (e.g., coordinate) data movement within the corresponding core 2402. The AL circuitry 2416 includes semiconductor-based circuits structured to perform one or more mathematic and/or logic operations on the data within the corresponding core 2402. The AL circuitry 2416 of some examples performs integer based operations. In other examples, the AL circuitry 2416 also performs floating point operations. In yet other examples, the AL circuitry 2416 may include first AL circuitry that performs integer based operations and second AL circuitry that performs floating point operations. In some examples, the AL circuitry 2416 may be referred to as an Arithmetic Logic Unit (ALU). The registers 2418 are semiconductor-based structures to store data and/or instructions such as results of one or more of the operations performed by the AL circuitry 2416 of the corresponding core 2402. For example, the registers 2418 may include vector register(s), SIMD register(s), general purpose register(s), flag register(s), segment register(s), machine specific register(s), instruction pointer register(s), control register(s), debug register(s), memory management register(s), machine check register(s), etc. The registers 2418 may be arranged in a bank as shown in FIG. 24. Alternatively, the registers 2418 may be organized in any other arrangement, format, or structure including distributed throughout the core 2402 to shorten access time. The bus 2422 may implement at least one of an I2C bus, a SPI bus, a PCI bus, or a PCIe bus.

Each core 2402 and/or, more generally, the microprocessor 2400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)), and/or other circuitry may be present. The microprocessor 2400 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

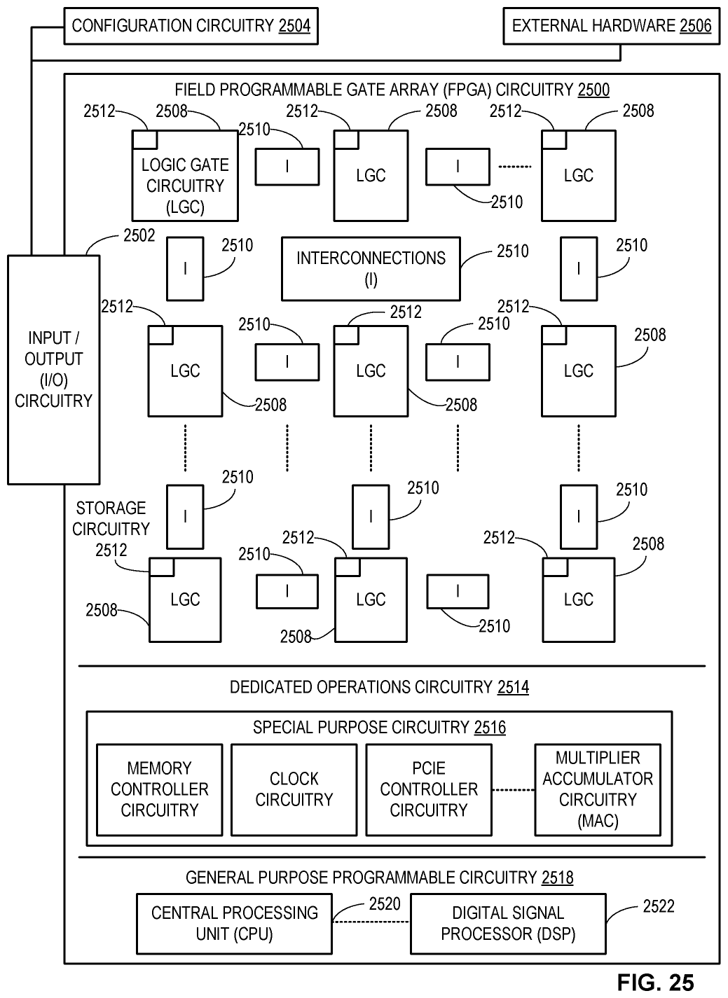

FIG. 25 is a block diagram of another example implementation of the processor circuitry 2302 of FIG. 23. In this example, the processor circuitry 2302 is implemented by FPGA circuitry 2500. The FPGA circuitry 2500 can be used, for example, to perform operations that could otherwise be performed by the example microprocessor 2400 of FIG. 24 executing corresponding machine-readable instructions. However, once configured, the FPGA circuitry 2500 instantiates the machine-readable instructions in hardware and, thus, can often execute the operations faster than they could be performed by a general purpose microprocessor executing the corresponding software.

More specifically, in contrast to the microprocessor 2400 of FIG. 24 described above (which is a general purpose device that may be programmed to execute some or all of the machine-readable instructions and/or operations 2200 represented by the flowchart of FIG. 22, but whose interconnections and logic circuitry are fixed once fabricated), the FPGA circuitry 2500 of the example of FIG. 25 includes interconnections and logic circuitry that may be configured and/or interconnected in different ways after fabrication to instantiate, for example, some or all of the machine-readable instructions and/or operations 2200 represented by the flowchart of FIG. 22. In particular, the FPGA circuitry 2500 may be thought of as an array of logic gates, interconnections, and switches. The switches can be programmed to change how the logic gates are interconnected by the interconnections, effectively forming one or more dedicated logic circuits (unless and until the FPGA circuitry 2500 is reprogrammed). The configured logic circuits enable the logic gates to cooperate in different ways to perform different operations on data received by input circuitry. Those operations may correspond to some or all of the software represented by the flowchart of FIG. 22. As such, the FPGA circuitry 2500 may be structured to effectively instantiate some or all of the machine-readable instructions 2200 of the flowchart of FIG. 22 as dedicated logic circuits to perform the operations corresponding to those software instructions in a dedicated manner analogous to an ASIC. Therefore, the FPGA circuitry 2500 may perform the operations corresponding to the some or all of the machine-readable instructions 2200 of FIG. 22 faster than the general purpose microprocessor can execute the same.

In the example of FIG. 25, the FPGA circuitry 2500 is structured to be programmed (and/or reprogrammed one or more times) by an end user by a hardware description language (HDL) such as Verilog. The FPGA circuitry 2500 of FIG. 25 includes example input/output (I/O) circuitry 2502 to obtain and/or output data to/from example configuration circuitry 2504 and/or external hardware (e.g., external hardware circuitry) 2506. For example, the configuration circuitry 2504 may implement interface circuitry that may obtain machine-readable instructions to configure the FPGA circuitry 2500, or portion(s) thereof. In some such examples, the configuration circuitry 2504 may obtain the machine-readable instructions from a user, a machine (e.g., hardware circuitry (e.g., programmed, or dedicated circuitry) that may implement an Artificial Intelligence/Machine Learning (AI/ML) model to generate the instructions), etc. In some examples, the external hardware 2506 may implement the microprocessor 2400 of FIG. 24. The FPGA circuitry 2500 also includes an array of example logic gate circuitry 2508, a plurality of example configurable interconnections 2510, and example storage circuitry 2512. The logic gate circuitry 2508 and interconnections 2510 are configurable to instantiate one or more operations that may correspond to at least some of the machine-readable instructions 2200 of FIG. 22 and/or other desired operations. The logic gate circuitry 2508 shown in FIG. 25 is fabricated in groups or blocks. Each block includes semiconductor-based electrical structures that may be configured into logic circuits. In some examples, the electrical structures include logic gates (e.g., AND gates, OR gates, NOR gates, etc.) that provide basic building blocks for logic circuits. Electrically controllable switches (e.g., transistors) are present within each of the logic gate circuitry 2508 to enable configuration of the electrical structures and/or the logic gates to form circuits to perform desired operations. The logic gate circuitry 2508 may include other electrical structures such as look-up tables (LUTs), registers (e.g., flip-flops or latches), multiplexers, etc.

The interconnections 2510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2508 to program desired logic circuits.

The storage circuitry 2512 of the illustrated example is structured to store result(s) of the one or more of the operations performed by corresponding logic gates. The storage circuitry 2512 may be implemented by registers or the like. In the illustrated example, the storage circuitry 2512 is distributed amongst the logic gate circuitry 2508 to facilitate access and increase execution speed.

The example FPGA circuitry 2500 of FIG. 25 also includes example Dedicated Operations Circuitry 2514. In this example, the Dedicated Operations Circuitry 2514 includes special purpose circuitry 2516 that may be invoked to implement commonly used functions to avoid the need to program those functions in the field. Examples of such special purpose circuitry 2516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2500 may also include example general purpose programmable circuitry 2518 such as an example CPU 2520 and/or an example DSP 2522. Other general purpose programmable circuitry 2518 may additionally or alternatively be present such as a GPU, an XPU, etc., that can be programmed to perform other operations.

Although FIGS. 24 and 25 illustrate two example implementations of the processor circuitry 2302 of FIG. 23, many other approaches are contemplated. For example, as mentioned above, modern FPGA circuitry may include an on-board CPU, such as one or more of the example CPU 2520 of FIG. 25. Therefore, the processor circuitry 2302 of FIG. 23 may additionally be implemented by combining the example microprocessor 2400 of FIG. 24 and the example FPGA circuitry 2500 of FIG. 25. In some such hybrid examples, a first portion of the machine-readable instructions and/or operations 2200 represented by the flowchart of FIG. 22 may be executed by one or more of the cores 2402 of FIG. 24 and a second portion of the machine-readable instructions and/or operations 2200 represented by the flowchart of FIG. 22 may be executed by the FPGA circuitry 2500 of FIG. 25.

In some examples, the processor circuitry 2302 of FIG. 23 may be in one or more packages. For example, the microprocessor 2400 of FIG. 24 and/or the FPGA circuitry 2500 of FIG. 25 may be in one or more packages. In some examples, an XPU may be implemented by the processor circuitry 2302 of FIG. 23, which may be in one or more packages. For example, the XPU may include a CPU in one package, a DSP in another package, a GPU in yet another package, and an FPGA in still yet another package.

From the foregoing, it will be appreciated that the above-disclosed methods and apparatus advantageously present location-based food movement notifications that intuitively inform the user of the grill (e.g., via one or more viewable, light-based indication(s)) of one or more area(s) and/or location(s) within the cooking chamber of the grill at which one or more associated food movement step(s) of a cook program being executed by the controller of the grill is/are to be performed. Such location-based food movement notifications advantageously reduce (e.g., minimize and/or remove) the degree of guesswork and/or judgment which the user must otherwise exercise when deciding which specific area(s) and/or specific location(s) within the cooking chamber of the grill the above-described conventional textual and/or graphical user notifications associated with certain food movement steps of the cook program might apply to. The disclosed methods and apparatus accordingly improve the overall quality of the cooking experience associated with preparing an item of food utilizing a cook program, and also provide a user experience that is improved relative to that provided by known cook program implementations.

In some examples, a grill is disclosed. In some disclosed examples, the grill comprises a cookbox, a lid, a cooking chamber, a controller, and a lighting module. In some disclosed examples, the lid is movable relative to the cookbox between a closed position and an open position. In some disclosed examples, the cooking chamber is defined by the cookbox and the lid, and is accessible to a user of the grill when the lid is in the open position. In some disclosed examples, the controller is to implement a cook program to cook an item of food within the cooking chamber. In some disclosed examples, the cook program includes a plurality of ordered steps, including a food movement step requiring the item of food to be added to the cooking chamber, to be removed from the cooking chamber, or to be moved within the cooking chamber. In some disclosed examples, the controller, in response to determining that the cook program has advanced to the food movement step, is to cause the lighting module to present a location-based food movement notification indicating a location within the cooking chamber at which the food movement step is to be performed.

In some disclosed examples, the lighting module includes a light source, and presenting the location-based food movement notification includes illuminating the light source.

In some disclosed examples, the lighting module includes a light source, and presenting the location-based food movement notification includes pulsing the light source.

In some disclosed examples, the lighting module includes a plurality of light sources, and presenting the location-based food movement notification includes illuminating respective ones of the light sources according to a pattern. In some disclosed examples, the pattern indicates a direction within the cooking chamber in which the food movement step is to be performed.

In some disclosed examples, the lighting module includes a plurality of light sources, and presenting the location-based food movement notification includes illuminating respective ones of the light sources according to a pattern. In some disclosed examples, the pattern indicates a time at which the food movement step is to be performed.

In some disclosed examples, the lighting module is spatially aligned with an area occupied by a cooking grate located within the cooking chamber. In some disclosed examples, the location is the area occupied by the cooking grate.

In some disclosed examples, the lighting module is spatially aligned with a burner located within the cooking chamber. In some disclosed examples, the location is directly over the burner.

In some disclosed examples, the lighting module includes a plurality of light sources arranged as a ring. In some disclosed examples, the ring is concentrically positioned relative to a control knob of the grill. In some disclosed examples, the control knob is movable to control a flow of gas to a burner located within the cooking chamber.

In some disclosed examples, the lighting module includes a plurality of light sources arranged as a linear series.

In some disclosed examples, the linear series is positioned between a first control button and a second control button of the grill. In some disclosed examples, the first control button and the second control button are actuatable to control a flow of gas to a burner located within the cooking chamber.

In some examples, a method is disclosed. In some disclosed examples, the method comprises implementing, via a controller of a grill, a cook program to cook an item of food within a cooking chamber of the grill. In some disclosed examples, the cooking chamber is defined by a cookbox and a lid of the grill. In some disclosed examples, the lid is movable relative to the cookbox between a closed position and an open position. In some disclosed examples, the cooking chamber is accessible to a user of the grill when the lid is in the open position. In some disclosed examples, the cook program includes a plurality of ordered steps, the plurality of ordered steps including a food movement step requiring the item of food to be added to the cooking chamber, to be removed from the cooking chamber, or to be moved within the cooking chamber. In some disclosed examples, the method further comprises, in response to determining that the cook program has advanced to the food movement step, presenting, via a lighting module of the grill, a location-based food movement notification indicating a location within the cooking chamber at which the food movement step is to be performed.

In some disclosed examples of the method, the lighting module includes a light source, and presenting the location-based food movement notification includes illuminating the light source.

In some disclosed examples of the method, the lighting module includes a light source, and presenting the location-based food movement notification includes pulsing the light source.

In some disclosed examples of the method, the lighting module includes a plurality of light sources, and presenting the location-based food movement notification includes illuminating respective ones of the light sources according to a pattern. In some disclosed examples, the pattern indicates a direction within the cooking chamber in which the food movement step is to be performed.

In some disclosed examples of the method, the lighting module includes a plurality of light sources, and presenting the location-based food movement notification includes illuminating respective ones of the light sources according to a pattern. In some disclosed examples, the pattern indicates a time at which the food movement step is to be performed.

In some disclosed examples of the method, the lighting module is spatially aligned with an area occupied by a cooking grate located within the cooking chamber. In some disclosed examples, the location is the area occupied by the cooking grate.

In some disclosed examples of the method, the lighting module is spatially aligned with a burner located within the cooking chamber. In some disclosed examples, the location is directly over the burner.

In some examples, a non-transitory computer-readable medium comprising computer-readable instructions is disclosed. In some disclosed examples, the instructions, when executed, cause one or more processors of a grill to implement a cook program to cook an item of food within a cooking chamber of the grill. In some disclosed examples, the cooking chamber is defined by a cookbox and a lid of the grill. In some disclosed examples, the lid is movable relative to the cookbox between a closed position and an open position. In some disclosed examples, the cooking chamber is accessible to a user of the grill when the lid is in the open position. In some disclosed examples, the cook program includes a plurality of ordered steps, the plurality of ordered steps including a food movement step requiring the item of food to be added to the cooking chamber, to be removed from the cooking chamber, or to be moved within the cooking chamber. In some disclosed examples, the instructions, when executed, cause the one or more processors, in response to determining that the cook program has advanced to the food movement step, to instruct a lighting module of the grill to present a location-based food movement notification indicating a location within the cooking chamber at which the food movement step is to be performed.

In some disclosed examples, the instructions, when executed, cause the lighting module to present the location-based food movement notification by illuminating a light source of the lighting module.

In some disclosed examples, the instructions, when executed, cause the lighting module to present the location-based food movement notification by pulsing a light source of the lighting module.

In some disclosed examples, the instructions, when executed, cause the lighting module to present the location-based food movement notification by illuminating respective ones of a plurality of light sources if the lighting module according to a pattern. In some disclosed examples, the pattern indicates a direction within the cooking chamber in which the food movement step is to be performed.

In some disclosed examples, the instructions, when executed, cause the lighting module to present the location-based food movement notification by illuminating respective ones of a plurality of light sources of the lighting module according to a pattern. In some disclosed examples, the pattern indicates a time at which the food movement step is to be performed.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. A grill, comprising:
a cookbox;
a lid movable relative to the cookbox between a closed position and an open position;
a cooking chamber defined by the cookbox and the lid, the cooking chamber accessible to a user of the grill when the lid is in the open position;
a controller to:
implement a cook program to cook an item of food within the cooking chamber, the cook program including a plurality of ordered steps, the plurality of ordered steps including a food movement step requiring the item of food to be added to the cooking chamber, to be removed from the cooking chamber, or to be moved within the cooking chamber; and
in response to determining that the cook program has advanced to the food movement step, cause a lighting module of the grill to present a location-based food movement notification indicating a location within the cooking chamber at which the food movement step is to be performed.

2. The grill of claim 1, wherein the lighting module includes a light source, and presenting the location-based food movement notification includes illuminating the light source.

3. The grill of claim 1, wherein the lighting module includes a light source, and presenting the location-based food movement notification includes pulsing the light source.

4. The grill of claim 1, wherein the lighting module includes a plurality of light sources, and presenting the location-based food movement notification includes illuminating respective ones of the light sources according to a pattern, the pattern indicating a direction within the cooking chamber in which the food movement step is to be performed.

5. The grill of claim 1, wherein the lighting module includes a plurality of light sources, and presenting the location-based food movement notification includes illuminating respective ones of the light sources according to a pattern, the pattern indicating a time at which the food movement step is to be performed.

6. The grill of claim 1, wherein the lighting module is spatially aligned with an area occupied by a cooking grate located within the cooking chamber, and wherein the location is the area occupied by the cooking grate.

7. The grill of claim 1, wherein the lighting module is spatially aligned with a burner located within the cooking chamber, and wherein the location is directly over the burner.

8. The grill of claim 1, wherein the lighting module includes a plurality of light sources arranged as a ring, the ring concentrically positioned relative to a control knob of the grill, the control knob movable to control a flow of gas to a burner located within the cooking chamber.

9. The grill of claim 1, wherein the lighting module includes a plurality of light sources arranged as a linear series.

10. The grill of claim 9, wherein the linear series is positioned between a first control button and a second control button of the grill, the first control button and the second control button actuatable to control a flow of gas to a burner located within the cooking chamber.

11. A method, comprising:
implementing, via a controller of a grill, a cook program to cook an item of food within a cooking chamber of the grill, the cooking chamber defined by a cookbox and a lid of the grill, the lid movable relative to the cookbox between a closed position and an open position, the cooking chamber accessible to a user of the grill when the lid is in the open position, the cook program including a plurality of ordered steps, the plurality of ordered steps including a food movement step requiring the item of food to be added to the cooking chamber, to be removed from the cooking chamber, or to be moved within the cooking chamber; and
in response to determining that the cook program has advanced to the food movement step, presenting, via a lighting module of the grill, a location-based food movement notification indicating a location within the cooking chamber at which the food movement step is to be performed.

12. The method of claim 11, wherein the lighting module includes a light source, and presenting the location-based food movement notification includes illuminating the light source.

13. The method of claim 11, wherein the lighting module includes a light source, and presenting the location-based food movement notification includes pulsing the light source.

14. The method of claim 11, wherein the lighting module includes a plurality of light sources, and presenting the location-based food movement notification includes illuminating respective ones of the light sources according to a pattern, the pattern indicating a direction within the cooking chamber in which the food movement step is to be performed.

15. The method of claim 11, wherein the lighting module includes a plurality of light sources, and presenting the location-based food movement notification includes illuminating respective ones of the light sources according to a pattern, the pattern indicating a time at which the food movement step is to be performed.

16. A non-transitory computer-readable medium comprising computer-readable instructions that, when executed, cause one or more processors of a grill to at least:
implement a cook program to cook an item of food within a cooking chamber of the grill, the cooking chamber defined by a cookbox and a lid of the grill, the lid movable relative to the cookbox between a closed position and an open position, the cooking chamber accessible to a user of the grill when the lid is in the open position, the cook program including a plurality of ordered steps, the plurality of ordered steps including a food movement step requiring the item of food to be added to the cooking chamber, to be removed from the cooking chamber, or to be moved within the cooking chamber; and
in response to determining that the cook program has advanced to the food movement step, instruct a lighting module of the grill to present a location-based food movement notification indicating a location within the cooking chamber at which the food movement step is to be performed.

17. The non-transitory computer-readable medium of claim 16, wherein the computer-readable instructions, when executed, cause the lighting module to present the location-based food movement notification by illuminating a light source of the lighting module.

18. The non-transitory computer-readable medium of claim 16, wherein the computer-readable instructions, when executed, cause the lighting module to present the location-based food movement notification by pulsing a light source of the lighting module.

19. The non-transitory computer-readable medium of claim 16, wherein the computer-readable instructions, when executed, cause the lighting module to present the location-based food movement notification by illuminating respective ones of a plurality of light sources of the lighting module according to a pattern, the pattern indicating a direction within the cooking chamber in which the food movement step is to be performed.

20. The non-transitory computer-readable medium of claim 16, wherein the computer-readable instructions, when executed, cause the lighting module to present the location-based food movement notification by illuminating respective ones of a plurality of light sources of the lighting module according to a pattern, the pattern indicating a time at which the food movement step is to be performed.
